(19) United States
(12) Patent Application Publication
(10) Pub. No.: US 2016/0352887 A1
(43) Pub. Date: Dec. 1, 2016

(54) ELECTRONIC DEVICE AND METHOD OF PROCESSING INFORMATION BASED ON CONTEXT IN ELECTRONIC DEVICE

(71) Applicant: Samsung Electronics Co., Ltd., Suwon-si (KR)

(72) Inventors: Min-Wook NA, Suwon-si (KR); Han-Kyung JEON, Anyang-si (KR); Min-Ho YANG, Suwon-si (KR); Eun-Bee JEON, Incheon (KR); Jeong-Hyun PANG, Seongnam-si (KR); Min-Kyung HWANG, Seoul (KR); Geon-Soo KIM, Suwon-si (KR)

(21) Appl. No.: 15/163,170

(22) Filed: May 24, 2016

(30) Foreign Application Priority Data
May 26, 2015 (KR) 10-2015-0073232

(51) Int. Cl. H04M 1/725; G06F 17/21

(52) U.S. Cl. CPC H04M 1/72527; H04M 1/72552; H04M 1/72569; G06F 17/212

(57) ABSTRACT

An electronic device is provided. The electronic device includes an operation of displaying at least one message on the display screen of a display, an operation of identifying context information related to the at least one message, and an operation of providing background information of a message display area of the display screen based on the identified context information. Accordingly, it is possible to enhance a user's interest in message communication.

### CROSS-REFERENCE TO RELATED APPLICATION(S)

This application claims the benefit under 35 U.S.C. §119(a) of a Korean patent application filed on May 26, 2015 in the Korean Intellectual Property Office and assigned Serial number 10-2015-0073232, the entire disclosure of which is hereby incorporated by reference.

### TECHNICAL FIELD

The present disclosure relates to an electronic device and a method of processing information based on context in an electronic device.

### BACKGROUND

Recently, electronic devices have been developed, to include various functions, for example, capturing of a picture or video, Internet communication, and the like, in addition to a simple call function. As the electronic devices include various functions, the electronic devices can exchange messages with counterparts through message communication and various applications therefor are being developed.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device and a method of processing information based on context in an electronic device.

The electronic device may exchange a message with a counterpart and identify a plurality of exchanged messages in chronological order through a scroll operation.

The electronic device may provide a message service through a scheme for providing various emoticons and skins as well as a function for displaying messages exchanged through an application related to the message communication.

However, the electronic device may display the exchanged message or contents according to a configured message display format. Accordingly, the electronic device may display a background of an area where the messages are displayed as a configured background image. When a user desires to change the message display format, the user may directly change the message display format such as a font, background image, emoticon, or user information.

Various embodiments of the present disclosure may provide an electronic device capable of processing information on an area where messages are displayed on a screen based on, for example, context and a method of processing information based on context by an electronic device.

In accordance with an aspect of the present disclosure, a method is provided. The method includes displaying a message received from an external electronic device by an electronic device, the displaying of the message including presenting first background information in connection with the message, identifying context information related to the message, determining second background information based on the context information, and providing the second background information in connection with the displayed message.

In accordance with another aspect of the present disclosure, an electronic device is provided. The electronic device includes a memory that stores a plurality of pieces of background information including first background information and second background information, and a controller that manages a message, wherein the controller makes a control to display a message received from an external electronic device, the displaying of the message comprising providing first background information in connection with the message, to identify context information related to the message, to select second background information based on the context information, and to provide the second background information in connection with the displayed message.

In accordance with another aspect of the present disclosure, an electronic device is provided. The electronic device includes a display for displaying at least one message on the display screen, and a processor configured to identify context information related to the at least one message that is displayed on the display screen, and provide background information of a message display area of the display screen based on the identified context information.

In accordance with another aspect of the present disclosure, a method of processing information by an electronic device is provided. The method includes displaying at least one message on the display screen of a display, identifying context information related to the at least one message, and providing background information of a message display area of the display screen based on the identified context information.

Based on an electronic device according to various embodiments and an operation of the electronic device, the electronic device can change and provide background information of a message display screen according to context related to at least one message, thereby enhancing a user's interest in message communication.

Further, based on an electronic device according to various embodiments and an operation of the electronic device, the electronic device can grasp user experience (UX) elements, that is, a flow changed according to context at a message transmission/reception time point by a user's scroll input.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment according to various embodiments of the present disclosure;

FIG. 2 illustrates an example of a configuration of a communication system according to various embodiments of the present disclosure;

FIG. 3 illustrates an example of a configuration of an electronic device according to an embodiment of the present disclosure;

FIG. 4 illustrates an operation process of the electronic device according to various embodiments of the present disclosure;

FIGS. 5A to 5C illustrate a message display screen of the electronic device according to various embodiments of the present disclosure;

FIGS. 6A and 6B illustrate a message display screen of the electronic device according to various embodiments of the present disclosure;

FIG. 7 illustrates an operation process of the electronic device according to various embodiments of the present disclosure;

FIG. 8 illustrates a message display screen of the electronic device according to various embodiments of the present disclosure;

FIG. 9 illustrates a message display screen of the electronic device according to various embodiments of the present disclosure;

FIG. 10 illustrates a message display screen of the electronic device according to various embodiments of the present disclosure;

FIG. 11 illustrates a message display screen of the electronic device according to various embodiments of the present disclosure;

FIG. 12 illustrates a message display screen of the electronic device according to various embodiments of the present disclosure;

FIGS. 13A and 13B illustrate a message display screen of the electronic device according to various embodiments of the present disclosure;

FIGS. 14A and 14B illustrate a message display screen of the electronic device according to various embodiments of the present disclosure;

FIGS. 15A to 15C illustrate a message display screen of the electronic device according to various embodiments of the present disclosure;

FIGS. 16A to 16C illustrate a message display screen of the electronic device according to various embodiments of the present disclosure;

FIG. 17 illustrates a message display screen of the electronic device according to various embodiments of the present disclosure;

FIG. 18 illustrates a message display screen of the electronic device according to various embodiments of the present disclosure;

FIG. 19 illustrates a message display screen of the electronic device according to various embodiments of the present disclosure;

FIG. 20 illustrates a message display screen of the electronic device according to various embodiments of the present disclosure;

FIGS. 21A and 21B illustrate a message display screen of the electronic device according to various embodiments of the present disclosure;

FIGS. 22A to 22C illustrate a message display screen of the electronic device according to various embodiments of the present disclosure;

FIG. 23 is a block diagram of the electronic device according to various embodiments of the present disclosure; and

FIG. 24 is a block diagram of a program module according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a Moving Picture Experts Group (MPEG-1 of MPEG-2) audio layer-3 (MP3) player, a mobile medical device, a camera, and a wearable device. According to various embodiments of the present disclosure, the wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

According to some embodiments of the present disclosure, the electronic device may be a home appliance. The smart home appliance may include at least one of, for example, a television (TV), a digital versatile disc (DVD) player, an audio device, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA) device, a magnetic resonance imaging (MRI) device, a computed tomography (CT) machine, and an ultrasonic machine), a navigation device, a global positioning system (GPS) receiver, an event data recorder (EDR), a flight data recorder (FDR), a Vehicle Infotainment Device, an electronic device for a ship (e.g., a navigation device for a ship, and a gyro-compass), avionics, a security device, an automotive head unit, a robot for home or industry, an automatic teller's machine (ATM) in banks, point of sales (POS) in a shop, or Internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). In various embodiments of the present disclosure, the electronic device may be a combination of one or more of the aforementioned various devices. According to some embodiments of the present disclosure, the electronic device may also be a flexible electronic device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. In the present disclosure, the term “user” may indicate a person using an electronic device or a device (e.g. an artificial intelligence electronic device) using an electronic device.

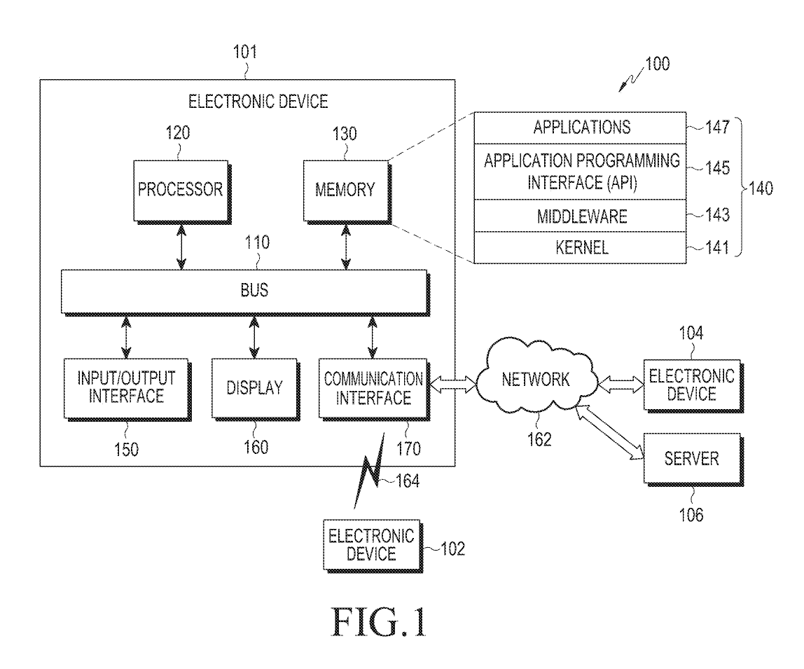

FIG. 1 illustrates a network environment according to various embodiments of the present disclosure.

Referring to FIG. 1, an electronic device 101 within a network environment 100, according to various embodiments of the present disclosure. The electronic device 101 may include a bus 110, a processor 120, a memory 130, an input/output interface 150, a display 160, and a communication interface 170. In some embodiments of the present disclosure, the electronic device 101 may omit at least one of the elements, or may further include other elements.

The bus 110 may include, for example, a circuit for connecting the elements 110 to 170 and transferring communication (for example, control messages and/or data) between the elements.

The processor 120 may include one or more of a CPU, an AP, and a communication processor (CP). For example, the processor 120 may carry out operations or data processing relating to control and/or communication of at least one other element of the electronic device 101.

The memory 130 may include a volatile memory and/or a non-volatile memory. The memory 130 may store, for example, instructions or data related to at least one other element of the electronic device 101. According to an embodiment of the present disclosure, the memory 130 may store software and/or a program 140. The program 140 may include, for example, a kernel 141, middleware 143, an application programming interface (API) 145, and/or applications (or “application programs”) 147. At least some of the kernel 141, the middleware 143, and the API 145 may be referred to as an operating system (OS).

The kernel 141 may control or manage system resources (for example, the bus 110, the processor 120, or the memory 130) used for performing an operation or function implemented by the other programs (for example, the middleware 143, the API 145, or the applications 147). Furthermore, the kernel 141 may provide an interface through which the middleware 143, the API 145, or the application programs 147 may access the individual elements of the electronic device 101 to control or manage the system resources.

The middleware 143, for example, may function as an intermediary for allowing the API 145 or the applications 147 to communicate with the kernel 141 to exchange data.

In addition, the middleware 143 may process one or more task requests received from the applications 147 according to priorities thereof. For example, the middleware 143 may assign priorities for using the system resources (for example, the bus 110, the processor 120, the memory 130, or the like) of the electronic device 101, to at least one of the applications 147. For example, the middleware 143 may perform scheduling or load balancing on the one or more task requests by processing the one or more task requests according to the priorities assigned thereto.

The API 145 is an interface through which the applications 147 control functions provided from the kernel 141 or the middleware 143, and may include, for example, at least one interface or function (for example, instruction) for file control, window control, image processing, or text control.

The input/output interface 150 may function as, for example, an interface that may transfer instructions or data input from a user or another external device to the other element(s) of the electronic device 101. Furthermore, the input/output interface 150 may output the instructions or data received from the other element(s) of the electronic device 101 to the user or another external device.

The display 160 may include, for example, a liquid crystal display (LCD), a light-emitting diode (LED) display, an organic light-emitting diode (OLED) display, a microelectromechanical systems (MEMS) display, and an electronic paper display. The display 160 may display, for example, various types of contents (for example, text, images, videos, icons, or symbols) for the user. The display 160 may include a touch screen and receive, for example, a touch, gesture, proximity, or hovering input by using an electronic pen or the user's body part.

The communication interface 170 may set communication between, for example, the electronic device 101 and an external device (for example, a first external electronic device 102, a second external electronic device 104, or a server 106). For example, the communication interface 170 may be connected to a network 162 through wireless or wired communication to communicate with the external device (for example, the external electronic device 104 or the server 106).

The wireless communication may use at least one of, for example, long term evolution (LTE), LTE-advance (LTE-A), code division multiple access (CDMA), wideband CDMA (WCDMA), universal mobile telecommunications system (UMTS), WiBro (wireless broadband), and global system for mobile communications (GSM), as a cellular communication protocol. In addition, the wireless communication may include, for example, short range communication 164. The short-range communication 164 may be performed by using at least one of, for example, Wi-Fi, Bluetooth (BT), near field communication (NFC), and global navigation satellite system (GNSS). The GNSS may include at least one of, for example, a GPS, a global navigation satellite system (Glonass), a Beidou Navigation Satellite System (hereinafter referred to as “Beidou”), and a European global satellite-based navigation system (Galileo), according to a use area, a bandwidth, or the like. Hereinafter, in the present disclosure, the “GPS” may be interchangeably used with the “GNSS”. The wired communication may include at least one of, for example, a universal serial bus (USB), a high definition multimedia interface (HDMI), recommended standard 232 (RS-232), and a plain old telephone service (POTS). The network 162 may include at least one of a communication network such as a computer network (for example, a local area network (LAN) or a wide area network (WAN)), the Internet, and a telephone network.

Each of the first external electronic device and the second external electronic device 102 and 104 may be a device which is the same type as or a different type from the electronic device 101. According to an embodiment of the present disclosure, the server 106 may include a group of one or more servers. According to various embodiments of the present disclosure, all or some of the operations performed in the electronic device 101 may be performed in another electronic device or a plurality of electronic devices (e.g., the electronic devices 102 and 104 or the server 106). According to an embodiment of the present disclosure, when the electronic device 101 has to perform some functions or services automatically or in response to a request, the electronic device 101 may make a request for performing at least some functions relating thereto to another device (for example, the electronic device 102 or 104 or the server 106) instead of performing the functions or services by itself or in addition. Another electronic device (for example, the electronic device 102 or 104, or the server 106) may execute the requested functions or the additional functions, and may deliver a result of the execution to the electronic device 101. The electronic device 101 may process the received result as it is or additionally to provide the requested functions or services. To achieve this, for example, cloud computing, distributed computing, or client-server computing technology may be used.

Hereinafter, an electronic device according to various embodiments of the present disclosure will be described with reference to the accompanying drawings.

Hereinafter, according to various embodiments of the present disclosure, the electronic device may use, for example, an application related to message communication in order perform an operation related to the message communication, but the present disclosure is not limited thereto and the electronic device may perform the operation related to the message communication through another function of the electronic device which can perform the message communication. Further, message communication described in various embodiments of the present disclosure may refer to transmitting or/and receiving a message based on a link with an external electronic device through a communication network. In various embodiments of the present disclosure, a screen of a display unit which may display messages transmitted or/and received through message communication may be described as a message display screen, and the message display screen may be at least one of a part of the display unit of the electronic device or an entire screen. An area of the message display screen on which the messages are displayed may be described as a message display area. The message display area may be at least one of an entire area or a partial area of the message display screen.

Background information described in various embodiments of the present disclosure may refer to information output in the form of at least one of an image, a video, a sound, a smell, and a vibration as a background of the message display screen. The background information may be generated based on contents corresponding to context information related to message communication (or message). For example, the background information may include the contents or may be generated as information processed using the contents.

Context information described in various embodiments of the present disclosure may refer to information on an activity or a task generated in connection with a user or a device. Also, the context information may refer to information on context related to at least one message communication (transmission or/and reception) displayed on the message display screen and may include, for example, user context, physical environment context, computing system (for example, electronic device) context, and user-computer (for example, electronic device) interaction context.

The user context may include, for example, identity context (for example, at least one piece of user information between an identity and a name) and body context (user's biometric information (for example, at least one of a pulse, blood pressure, body temperature, and voice).

The physical environment context may include at last one of, for example, spatial context (for example, at least one of a location, direction, and speed), temporal context (for example, at least one of a time, date, day of the week, week, month, year, and season), environmental context (for example, at least one piece of weather information (for example, at least one of a temperature, humidity, illumination, noise, and wind direction), regional characteristic information, and geographic information), and a preset condition. Information related to the temporal context may be information related to a time (for example, at least one of a communication time, date, day of week, week, month, season, and year) of at least one message communication (transmission or reception). Context information related to the preset condition may be information configured for message communication (for example, information configured in an environment setting function of an application (or function) related to the message communication or information acquired through another application (or function) (for example, schedule information)).

The computing system context may include at least one of a state of the electronic device (device resources) (for example, at least one of a battery, display, Internet, and device state) and access context (for example, at least one of allowable information and proximity). Context information related to the state of the electronic device may correspond to information related to a state of the electronic device in the message communication, and may be information related to at least one of an on/off state of the electronic device, an execution state of an application related to a message, a communication enable/disable state, and a lock state.

The user-computer interaction context may include, for example, at least one of history context (for example, at least one of a user, service, and time), error context (for example, at least one of a time, user, and service-related error), and user input information according to a user's gesture or an input means.

In various embodiments of the present disclosure, an apparatus for performing an operation related to message communication of the electronic device and an operation process will be described in detail with reference to the drawings below.

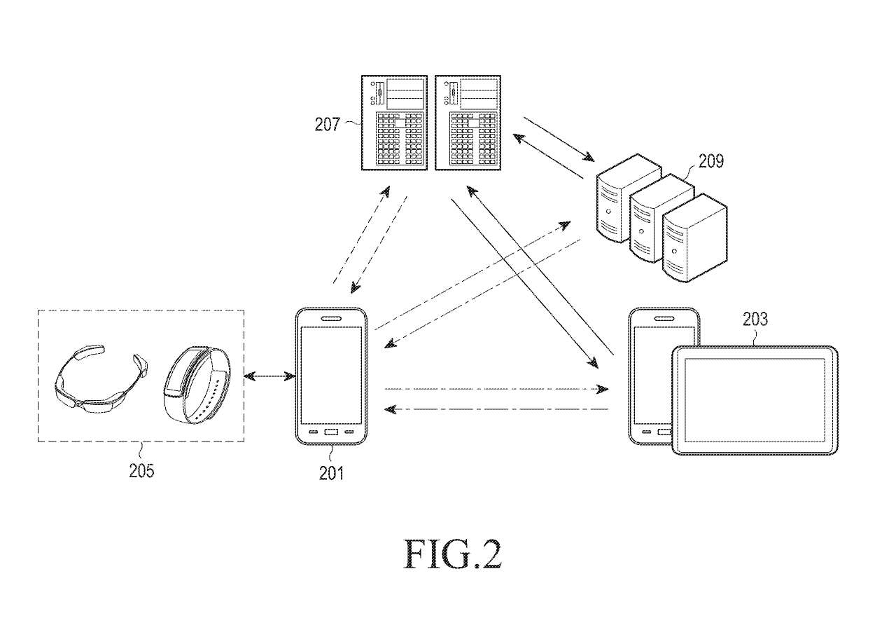

FIG. 2 illustrates an example of a configuration of a communication system according to various embodiments of the present disclosure.

Referring to FIG. 2, according to various embodiments of the present disclosure, the communication system may include at least one of a first electronic device 201, a second electronic device 203, a third electronic device 205, a server 207, and an information providing apparatus 209.

According to various embodiments of the present disclosure, the first electronic device 201 (for example, the electronic device 101 of FIG. 1) may perform message communication, that is, communication for transmitting or/and receiving messages to or/and from the second electronic device 203 (for example, the electronic device 102 or 104 of FIG. 1) and output at least message transmitted or/and received (also referred to as transceive) according to the message communication. According to various embodiments of the present disclosure, the first electronic device 201 may display contents of the messages (images (still image and dynamic image) in a message display area of a message display screen of a function (for example, a message-related application) for the message communication or may output the contents of the messages through, for example, a speaker.

According to various embodiments of the present disclosure, the first electronic device 201 may change background information of the message display screen (for example, a screen of an application executed based on the transmitted/received messages) on which the transmitted/received messages are displayed. Further, the first electronic device 201 may acquire user's biometric information based on the third electronic device 205 or at least one sensor included in the first electronic device 201, analyze the acquired biometric information, and change background information of the screen displaying the messages by using the analyzed biometric information. The change in the background information will be described in detail with reference to the drawings described below.

According to various embodiments of the present disclosure, the third electronic device 205 (for example, the electronic device 102 or 104 of FIG. 1) may be an electronic device (for example, a wearable device) which can perform communication (for example, short-range wireless communication) with the first electronic device 201 or the second electronic device 203. According to various embodiments of the present disclosure, the third electronic device 205 may detect user's biometric information and transmit the detected biometric information to the first electronic device 201 or the second electronic device 203.

According to various embodiments of the present disclosure, the server 207 (for example, the server 106 of FIG. 1) may communicate with the first electronic device 201 or the second electronic device 203 and provide information on the executed application and information related to the message communication. According to various embodiments of the present disclosure, the server 207 or the information providing apparatus 209 may provide information requested by the first electronic device 201 or the second electronic device 203 or contents related to transmitted/received message.

According to various embodiments of the present disclosure, the information providing apparatus 209 may provide various contents to the first electronic device 201 or the second electronic device 203. According to various embodiments of the present disclosure, the information providing apparatus 209 may directly provide contents to the first electronic device 201 or the second electronic device 203, or provide the contents to the first electronic device 201 or the second electronic device 203 through the server 207. According to various embodiments of the present disclosure, the information providing apparatus 209 may provide contents related to transmitted/received messages. The contents related to the transmitted/received messages may include, for example, at least one piece of information which can be provided in connection with contents of the messages, information for configuring background information, and information for executing an application, and the information may consist of an image, a video (for example, dynamic image), a sound (for example, a voice or a mechanical sound), and text or a combination thereof. The message may include at least one of a short message, a long message, a multimedia message, and email.

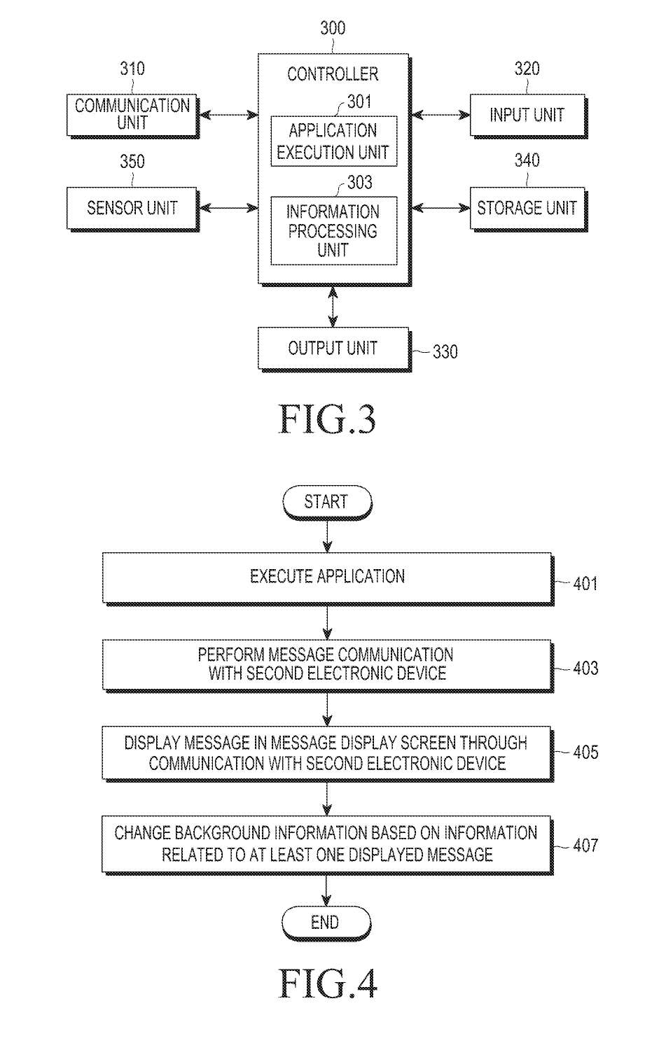

FIG. 3 illustrates an example of a configuration of an electronic device according to various embodiments of the present disclosure.

According to various embodiments of the present disclosure, the electronic device of FIG. 3 may be the electronic device 101 of FIG. 1, or be at least one of the first electronic device 201 and the second electronic device 203 described in the system of FIG. 2. Hereinafter, in the description made below with reference to FIG. 3, the electronic device of a message transmitting side may be referred to as a first electronic device and the electronic device of a message receiving side may be referred to as a second electronic, and vice versa.

Referring to FIG. 3, according to various embodiments of the present disclosure, the electronic device may include at least one of a controller 300, a communication unit 310, an input unit 320, an output unit 330, a storage unit 340, and a sensor unit 350. In some embodiments of the present disclosure, at least one of the elements of the electronic device may be omitted, or other elements may be additionally included.

According to various embodiments of the present disclosure, the controller 300 (for example, the processor 120 of FIG. 1) may process information according to an operation of the electronic device and information (for example, messages or contents) according to execution of an application or function, and make a control to display the information according to the execution of the application on a screen of the display unit.

According to various embodiments of the present disclosure, the controller 300 may perform a general control operation of the electronic device and perform a control operation related to message communication with at least one other electronic device. According to various embodiments of the present disclosure, the controller 300 may make a control to display a screen for displaying a transmitted/received message (for example, a message display screen of the display unit). Further, the controller 300 may make a control to change background information of the message display screen (or message display area) based on context information associated with at least one message displayed on the message display screen.

The controller 300 may include an application execution unit 301 for processing an operation according to execution of at least one application (for example, an application for transmitting/receiving a message) executed in the electronic device or an information processing unit 303 for processing various pieces of information related to an operation of the electronic device, for example, information according to execution of an application or function related to message communication.

According to various embodiments of the present disclosure, the application execution unit 301 of the controller 300 may control an operation related to the execution of the application and make a control to output the message transmitted/received through the executed application. Further, when the application related to the message communication is executed, the application execution unit 301 may make a control to output background information of the message display screen as initially configured background information or previously changed background information. According to various embodiments of the present disclosure, when a new message is generated, input information related to a background image change is received, or at least one event that meets a configured condition is generated after the application for transmitting/receiving the message is executed, the application execution unit 301 may make a control to change current background information displayed on the message display screen to generated background information and to output the changed background information as the background of the message display screen.

According to various embodiments of the present disclosure, when the changed background information is an image, the application execution unit 301 of the controller 300 may make a control to apply the changed background information to the message display screen, change the background image, and output the changed background image. Further, when the changed background information includes at least one piece of audio, vibration, or smell information, the application execution unit 301 may make a control to change at least one piece of the audio, vibration, or smell information included in the changed background information in a state where the current message display screen is displayed and to output the changed background information.

According to various embodiments of the present disclosure, the information processing unit 303 of the controller 300 may process all pieces of information according to the operation of the electronic device and process information according to execution of at least one application or function executed in the electronic device. According to various embodiments of the present disclosure, the information processing unit 303 may analyze and process the transmitted/received message and transfer the processed message information (for example, context information related to the message) to the application execution unit 301. Further, the information processing unit 303 may generate background information of the screen displaying the message based on the transmitted/received message and transfer the generated background information to the application execution unit 301. In addition, the information processing unit 303 may make a control to collect contents (for example, at least one of the contents related to the contents of the message or the contents related to context information according to message transmission/reception) related to the transmitted/received message and to process the collected contents in order to generate the background information.

The controller 300 according to various embodiments of the present disclosure may further include other elements in addition to the above described elements, and may omit at least one of the elements. The application execution unit 301 and the information processing unit 303 are not limited to the above description and may perform various control operations related to the message communication. The application execution unit 301 may perform some or all of the control operations of the information processing unit 303, and the information processing unit 303 may perform some or all of the control operations of the application execution unit 301. According to various embodiments of the present disclosure, some or all of the control operations of the application execution unit 301 or the information processing unit 303 may be performed by the added other element (for example, a message management module).

According to various embodiments of the present disclosure, when transmitting or receiving a new message through the message communication, the controller 300 may change background information of the message display screen based on the transmitted/received new message.

According to various embodiments of the present disclosure, the controller 300 may select a message located in a configured area of the message display area (for example, at least one of an uppermost part, a lowermost part, and a center part) and change the background information of the message display screen based on the selected message. When a plurality of messages displayed in the message display area are scrolled according to a user's particular gesture (for example, a scroll operation input), the controller 300 may select a message located in the configured area among the plurality of scrolled messages. The plurality of messages displayed in the message display area may be arranged in chronological order, and scrolled and displayed in accordance with a scroll speed. The controller 300 may make a control to skip some of the plurality of scrolled messages in accordance with the scroll speed. When there is a particular message having a particular mark in the plurality of scrolled messages, the controller 300 may make a control to reduce the scroll speed and then display the particular message on the message display screen.

According to various embodiments of the present disclosure, the controller 300 may make a control to output the message having the particular mark (for example, a bookmark). That is, the controller 300 may make a control to display the particular mark on a message determined as being important automatically based on settings or according to a user's selection. The controller 300 may fold and display a long message such as a multimedia message, and unfold and display the folded message according to particular input information.

According to various embodiments of the present disclosure, the controller 300 may change the background information of the message display screen based on at least one of the message transmitted or received during a predetermined period. According to various embodiments of the present disclosure, the controller 300 may select at least one message currently displayed in the message display area, for example, every 1 hour and change the background information based on at least one selected message. According to various embodiments of the present disclosure, the controller 300 may select at least one message currently displayed in the message display area, for example, at a predetermined time every day and change the background information based on information relate to at least one selected message.

According to various embodiments of the present disclosure, the controller 300 may select at least one message displayed in the message display area, identify context information related to at least one selected message, and collect contents corresponding to the identified context information. According to various embodiments of the present disclosure, when a communication time of at least one selected message and a configured theme (for example, weather) are identified as the context information, the controller 300 may collect contents related to weather corresponding to the configured theme at the communication time. According to various embodiments of the present disclosure, when the communication time of at least one selected message is identified as the context information, the controller 300 may identify whether, for example, it is night or day according to the identified communication time. According to various embodiments of the present disclosure, the controller 300 may collect contents related to night when the identified context information indicates night, and may collect contents related to day when the identified context information indicates day. According to various embodiments of the present disclosure, when the identified context information indicates a communication time (for example, at least one of year, month, date, and day of the week), the controller 300 may collect contents related to the communication time (for example, contents related to winter or contents related to Christmas when the communication time corresponds to December).

According to various embodiments of the present disclosure, the controller 300 may acquire a user's biometric information at a time point when at least one message is transmitted or received, and identified context information related to at least one message by using the acquired biometric information. The controller 300 may grasp, for example, a user's current emotional state by analyzing the acquired biometric information and collect contents corresponding to the grasped emotional state. According to various embodiments of the present disclosure, the controller 300 may grasp the user's emotional state according to information included in at least one selected message, that is, contents of the message, and collect contents corresponding to the grasped emotional state. According to various embodiments of the present disclosure, the controller 300 may grasp the user's emotional state by using at least one piece of input information among a message input speed of the user and a user's gesture.

According to various embodiments of the present disclosure, the controller 300 may collect contents corresponding to context information by linking with at least one other application based on the context information related to at least one message displayed in the message display area. The controller 300 may make a control to display, in one area of an application for transmitting/receiving a message, an image related to a link of another application and to display background information as a widget.

According to various embodiments of the present disclosure of the present disclosure, the controller 300 may receive contents from an external device (for example, the server 207 or the information providing apparatus 209 of FIG. 2) or load contents stored in the storage unit 340.

According to various embodiments of the present disclosure, the controller 300 may generate background information by using collected contents based on context information related to the transmitted/received message, and change the currently output background information, that is, current background information of the message display screen to the generated background information. According to various embodiments of the present disclosure, when the collected contents correspond to, for example, contents related to weather, the controller 300 may identify the collected contents to check a current weather state. When the current weather state corresponds to, for example, a raining state based on a result of the check, the controller 300 may generate a background showing rain (for example, at least one of a raining background image or video, a raining sound, and a smell associated with raining) based on the collected contents. According to various embodiments of the present disclosure, when a plurality of messages arranged in chronological order in the message display area are scrolled, the controller 300 may make a control to generate dynamic background information (for example, at least one of information including an object moving according to a time change and information showing successive changes) according to a time change based on a communication time of the plurality of messages and to output the generated dynamic background information according to the scroll.

According to various embodiments of the present disclosure, the controller 300 may make a control to output the generated background information in the message display area. The background information may be output along with at least one message displayed in the message display area and may be generated as the dynamic background information according to a time change. The controller 300 may generate a plurality of background information (for example, background images) by using collected contents, and, for example, sequentially output or combine and output the plurality of generated background images.

According to various embodiments of the present disclosure, the controller 300 may make a control to output at least one piece of context information related to the second electronic device or background information in one area of the message display screen such that the message display screen is distinguished from the message display area of the first electronic device. According to various embodiments of the present disclosure, the controller 300 may make a control to output an area for outputting context information or background information of the second electronic device by moving the currently output background information in one direction according to a user's particular gesture. The area for displaying the information of the second electronic device may be configured in, for example, one area of the current message display screen as an identification image for a second user displayed in the message display area is selected. According to various embodiments of the present disclosure, the controller 300 may change the background information currently output to the message display screen to the background of the second electronic device. That is, the controller 300 may make a control to output background information, which is the same as that of the second electronic device, by applying the background information of the message display screen output to the second electronic device to the background of the message display area of the first electronic device. The background information of the second electronic device may be background information directly generated by the first electronic device based on the context information received from the second electronic device or background information received from the second electronic device.

According to various embodiments of the present disclosure, the controller 300 may further include an operation execution unit (not shown) for executing the operation of the electronic device (for example, the electronic device 201 of FIG. 2). The operation execution unit may make a control to perform an operation in response to a user input or a detected input. According to various embodiments of the present disclosure, the operation execution unit may control the output unit 330 to display an execution screen, an application, or information according to operation execution or control various operations of the electronic device (for example, at least one of smell generation, vibration generation, an output of audio information through a speaker, an input of audio information through a microphone, an input through a touch, an output of information corresponding to a touch (for example, express texture of an object), and an operation related to a camera module).

According to various embodiments of the present disclosure, the controller 300 of the electronic device may be at least a part of a processor, and may include, for example, a combination of one or more of hardware, software, and firmware.

According to various embodiments of the present disclosure, at least some elements of the controller 300 of the electronic device may include, in hardware, at least some of at least one processor including a CPU/micro processing unit (MPU), a memory (for example, a register and/or a random access memory (RAM) to which at least one piece of memory loading data is loaded, and a bus for inputting/outputting at least one piece of data to the processor and the memory. Further, the controller 300 may include, in software, a predetermined program routine or program data which is loaded to the memory from a predetermined recording medium to perform a function defined in the electronic device and operation-processed by the processor.

According to various embodiments of the present disclosure, the communication unit 310 of the electronic device (for example, the communication interface 170 of FIG. 1) may communicate with, for example, another electronic device, or an external device (for example, the electronic device 102 or 104 or the server 106 of FIG. 1).

According to various embodiments of the present disclosure, the communication unit 310 may transmit or/and receive a message according to a control of the controller 300. For example, the communication unit may perform message communication with another electronic device, transfer the received message according to the message communication to the controller 300, and transmit the transferred message from the controller 300 to the other electronic device. According to various embodiments of the present disclosure, the communication unit 310 may receive contents corresponding to context information from an external electronic device and transfer the received contents to the controller 300.

The communication unit 310 may perform communication through a network (for example, the network 162 of FIG. 1) connection or a connection between devices through wireless communication or wired communication based on the communication interface. The wireless communication may include at least one of, for example, Wi-Fi, BT, NFC, GPS and cellular communication (for example, LTE, LTE-A, CDMA, WCDMA, UMTS, WiBro, GSM or the like). The wired communication may include at least one of, for example, a USB, a HDMI, RS-232, and a POTS. The communication unit may include all types of communication schemes which have been widely known or will be developed in the future as well as the aforementioned communication schemes.

According to various embodiments of the present disclosure, the input unit 320 of the electronic device (for example, the input/output interface 150 of FIG. 1) may transfer, to the controller 300, various pieces of information such as number and character information input from the user, various function settings, and signals which are input in connection with a control of functions of the electronic device. Further, the input unit 320 may support a user input for executing an application that supports a particular function. The input unit 320 may include one or more of a key input means such as a keyboard or a keypad, a touch input means such as a touch sensor or a touch pad, a sound source input means, various sensors, and a camera, and may further include a gesture input means. In addition, the input unit 320 may include all types of input means which are being developed currently or will be developed in the future. According to various embodiments of the present disclosure, the input unit 320 may receive information input by the user through a touch panel of a camera module (not shown) from the user and transfer the input information to the controller 300.

According to various embodiments of the present disclosure, the input unit 320 may transfer input information for executing an application related to the input message communication corresponding to the user's input to the controller 300. The input unit 320 may receive user input information on various functions of the executed application. The input unit 320 may receive at least one piece of user input information (for example, at least one of a gesture, tap, press (or touch and hold), pan, panning, swipe, swiping, scroll, flick, drag (or drag & drop), pinch output & pinch in, rotate, and a combination thereof) for changing background information or viewing a counterpart's background information and transfer the received input information to the controller 300. According to various embodiments of the present disclosure, the input unit 320 may receive message information included in a message to be transmitted, from the user or at least one of various input means and transfer the input message information to the controller 300.

According to various embodiments of the present disclosure, the output unit 330 (for example, the display 160 of FIG. 1) of the electronic device may display operation execution information and operation execution result information according to an operation control from an operation execution unit (not shown). The output unit 330 may output various pieces of information (for example, at least one of text, image, video, smell, and sound) to the user through at least one of a display unit, a vibration or smell output means, and a speaker). The output unit 330 may display, on a screen, an input window or an input pad (for example, a button) through which at least one of various characters, numbers, and symbols can be input into the input window in various ways. Further, the output unit 330 may display a service screen according to execution of various applications related to information transmission/reception.

According to various embodiments of the present disclosure, the output unit 330 of the electronic device may display information according to an operation of the executed application under a control of the controller 300. Further, the output unit 330 may display messages transmitted/received through communication with another device in one area of the message display screen. A background image, an object (for example, at least one of a transmitted/received message, emoticon, icon, setting menu and function menu) displayed on the background image may be displayed in the message display area (or message display window). The background image may be expressed by one image or a plurality of images.

Further, the output unit 330 may display information related to a counterpart (for example, at least one of background information displayed in another electronic device, a counterpart's context information, and an image or text set in accordance with a counterpart) in one area (for example, counterpart information display area) of the message display screen of the executed application under a control of the controller 300.

In addition, according to various embodiments of the present disclosure, when the display unit of the output unit 330 is implemented in a touch screen form, the input unit 320 and/or the display unit may correspond to the touch screen. When the display unit of the output unit 330 is implemented in the touch screen form together with the input unit 320, the display unit may display various pieces of information generated according to a user's touch action.

According to various embodiments of the present disclosure, the display unit of the output unit 330 may be configured by one or more of a LCD, a thin film transistor LCD (TFT-LCD), an OLED, LED, active matrix OLED (AMOLED), a flexible display, and a 3 dimensional display. Some of the displays may be implemented in a transparent type or a light transmission type so that the outside can be seen there through. The display may be implemented in a transparent display form including transparent OLED (TOLED).

According to various embodiments of the present disclosure, the storage unit 340 may temporarily store various pieces of data generated during execution of a program including a program required for an operation of a function according to various embodiments of the present disclosure. The storage unit 340 may largely include a program area and a data area. The program area may store pieces of information related to driving of the electronic device such as an OS that boots the electronic device. The data area may store transmitted/received data or generated data according to various embodiments of the present disclosure. Further, the storage unit 340 may include at least one storage medium of a flash memory, a hard disk, a multimedia card micro type memory (for example, a secure digital (SD) or extreme digital (XD) memory), a RAM, and a read-only memory (ROM).

According to various embodiments of the present disclosure, the storage unit 340 (for example, the memory 130 of FIG. 1) of the electronic device may store various pieces of information required for the operation of the electronic device. According to various embodiments of the present disclosure, the storage unit 340 may store information related to driving of an application, information related to message communication (for example, at least one of the transmitted/received message and context information), or information related to a change in background information. The information related to the change in the background information may include at least one piece of information identified based on the transmitted/received message, context information including at least one piece of a user's biometric information and analyzed user emotion information, collected contents, and generated background information, and also include various pieces of information related to the change in the background information.

Further, locations of the main elements of the electronic device illustrated in FIG. 3 can be changed according to various embodiments of the present disclosure.

As described above, the main elements of the electronic device of FIG. 3 have been described. However, not all elements illustrated in FIG. 3 are necessary components. The electronic device may be implemented by a larger number of elements than the illustrated elements or a smaller number of elements than the illustrated elements. For example, although it has been described that at least one sensor is included in the input unit 320, the electronic device may further include a separate sensor unit 350 having at least one sensor.

According to various embodiments of the present disclosure, the sensor unit 350 may acquire context information related to at least one of a time, user, surrounding environment, and state of the electronic device, required for generating background information of the message display screen through at least one sensor. At least one sensor may be a sensor which may detect, for example, at least one of a location motion, vibration, smell, sound, touch, speed, pressure, temperature, humidity, brightness, smoke, fog, and smog.

An electronic device according to one of the various embodiments of the present disclosure may includes a memory that stores a plurality of pieces of background information including first background information and second background information and a controller that manages a message, wherein the controller makes a control to display a message received from an external electronic device, the displaying of the message comprising providing first background information in connection with the message, to identify context information related to the message, to select second background information based on the context information, and to provide the second background information in connection with the displayed message.

According to various embodiments of the present disclosure, the message may include at least one of a message, a voice, a sound, an email, a photo, and a video.

The controller may identify, as the context information, at least one piece of information of a time, weather, date, temperature, location, and a schedule of when the message is received or transmitted, a user's biometric information, and information contained in the message.

According to various embodiments of the present disclosure, the controller may determine at least one of an image, a video, a sound, a smell, and a vibration as the second background information based on the context information.

According to various embodiments of the present disclosure, when the context information corresponds to an image, the controller may make a control to display the image to a user through a display functionally connected to the electronic device.

According to various embodiments of the present disclosure, the controller may make a control to move and display at least one of the message and the second background information based on a user input.

An electronic according to one of the various embodiments of the present disclosure may includes a display for displaying at least one message on the display screen, and a controller (for example, the processor 120 of FIG. 1) configured to identify context information related to the message that is displayed on the display screen, and provide background information of the message display area of the display screen based on the identified context information.

According to various embodiments of the present disclosure, the controller may make a control to collect contents corresponding to the identified context information, to generate the background information by using the collected contents, and to provide the generated background information as the background information of the message display area.

According to various embodiments of the present disclosure, the controller may make a control to move and display at least one of the message displayed in the message display area and the background information in response to a user input.

According to various embodiments of the present disclosure, the controller may make a control to change the background information of the message display area to background information stored in connection with a message moved to and displayed at a preset location of the message display area in response to a user input and to provide the changed background information.

According to various embodiments of the present disclosure, the controller may make a control to generate background information based on context information identified using information related to a message moved to and displayed at a preset location of the message display area in response to a user input, to change the background information of the message display area to the generated background information, and to provide the changed background information.

According to various embodiments of the present disclosure, the controller may make a control to skip at least one message moved to and displayed in the message display area in response to a user input and, when there is a particular message in a plurality of messages moved to and displayed in the message display area, to change the background information of the message display area to background information generated based on the particular message, and to provide the changed background information.

According to various embodiments of the present disclosure, the controller may change the background information of the message display area based on at least one message among messages transmitted or received during a predetermined period.

According to various embodiments of the present disclosure, the controller may collect contents in accordance with the context information and generate at least one of an image, a video, a sound, a smell, and a vibration as the background information of the message display area by using the collected contents.

According to various embodiments of the present disclosure, when moving and displaying a plurality of messages arranged in the message display area in chronological order in response to a user input, the controller may make a control to generate dynamic background information according to a time change based on a communication time of the plurality of messages and to provide the generated dynamic background information as the background information of the message display area.

According to various embodiments of the present disclosure, the controller may make a control to display background information for another user in one area of a screen of a display unit to be separated from the message display area.

According to various embodiments of the present disclosure, the controller may make a control to change the background information of the message display area to background information for another user.

Next, a method of processing information based on context in the electronic device configured as described above will be described in detail with reference to the accompanying drawings.

FIG. 4 illustrates an operation process of the electronic device according to various embodiments of the present disclosure.

Referring to FIG. 4, according to an embodiment of the present disclosure, a first electronic device (for example, the electronic device 101 of FIG. 1) may execute an application (or function) for message communication with a second electronic device (for example, the electronic device 102 or 104 of FIG. 1 as an external electronic device) and output information according to an operation of the executed application in operation 401. Further, according to various embodiments of the present disclosure, when the application is executed in operation 401, the first electronic device may output background information of an area of the message display screen in which a message is displayed as an initially configured image, an image configured when the application (or function) is executed, or previously changed background information.

In operation 403, the first electronic device may perform message communication with the second electronic device through the application related to the message communication executed by the first electronic device.

In operation 405, the first electronic device may output messages transmitted/received through the message communication on the message display screen. According to various embodiments of the present disclosure, the first electronic device may arrange and display a plurality of messages in the message display area in chronological order. Further, according to various embodiments of the present disclosure, when the plurality of messages arranged in the message display area in chronological order are scrolled, the first electronic device may skip some of the plurality of scrolled messages in accordance with a scroll speed and, when there is a particular message having a particular mark (for example, bookmark) in the plurality of scrolled messages, reduce the scroll speed, and then display the particular message on the message display screen.

In operation 407, the first electronic device may generate background information based on information related to at least one message displayed on the message display screen and change the background information output on the current message display screen to the generated background information.

FIG. 4 illustrates an operation for changing background information of the message display screen when the first electronic device according to various embodiments of the present disclosure displays a message on the message display screen through message communication. According to various embodiments of the present disclosure, when there is no transmitted/received message, that is, when a message is not displayed, the first electronic device may change background information of the message display screen based on identified context information at a time point when an application or function for message communication is executed, according to a user's request, or on a preset period.

According to various embodiments of the present disclosure, the first electronic device may identify context information related to at least one message communication displayed on the message display screen in order to change background information (for example, at least one of an image, audio data (sound), video, vibration, and smell information) of the message display screen.

According to various embodiments of the present disclosure, when an event for changing background information is generated, the first electronic device may identify context information related to at least one message displayed on the message display screen and change currently displayed background information to the generated background information by using contents corresponding to the identified context information. The event for changing the background information may be generated at regular time intervals, at a time point when a new message is displayed (or generated), at a time point when a user's input information is received, at a time point when a message including information of a configured theme is displayed (or generated), or according to a schedule configured by the user or a request received from an external device.

According to various embodiments of the present disclosure, when a plurality of messages arranged in the message display area in chronological order are scrolled, the first electronic device may select at least one message displayed in the message display area according to the scroll and identify context information related to at least one selected message. According to various embodiments of the present disclosure, the first electronic device may select a particular message having a preset mark in the plurality of messages and identify context information related to the selected particular message. According to various embodiments of the present disclosure, the first electronic device may identify the context information related to at least one message by using a user's biometric information acquired at a time point when at least one message is transmitted or received. Further, the first electronic device may analyze contents contained in at least one message and identify context information according to a result of the analysis.

According to various embodiments of the present disclosure, the first electronic device may receive user input information (for example, particular gesture) configured as a counterpart information view in the message display area (for example, one area of the message display area) of the entire screen including the executed application. When receiving the user input information, the first electronic device may divide the entire screen of the executed message display screen into the message display area and a counterpart information display area (for example, counterpart information display screen) and display background information generated according to counterpart context information in the counterpart information display area. The first electronic device may directly generate the counterpart background information by using counterpart context information received from a counterpart electronic device (second electronic device) or receive counterpart background information generated by the second electronic device.

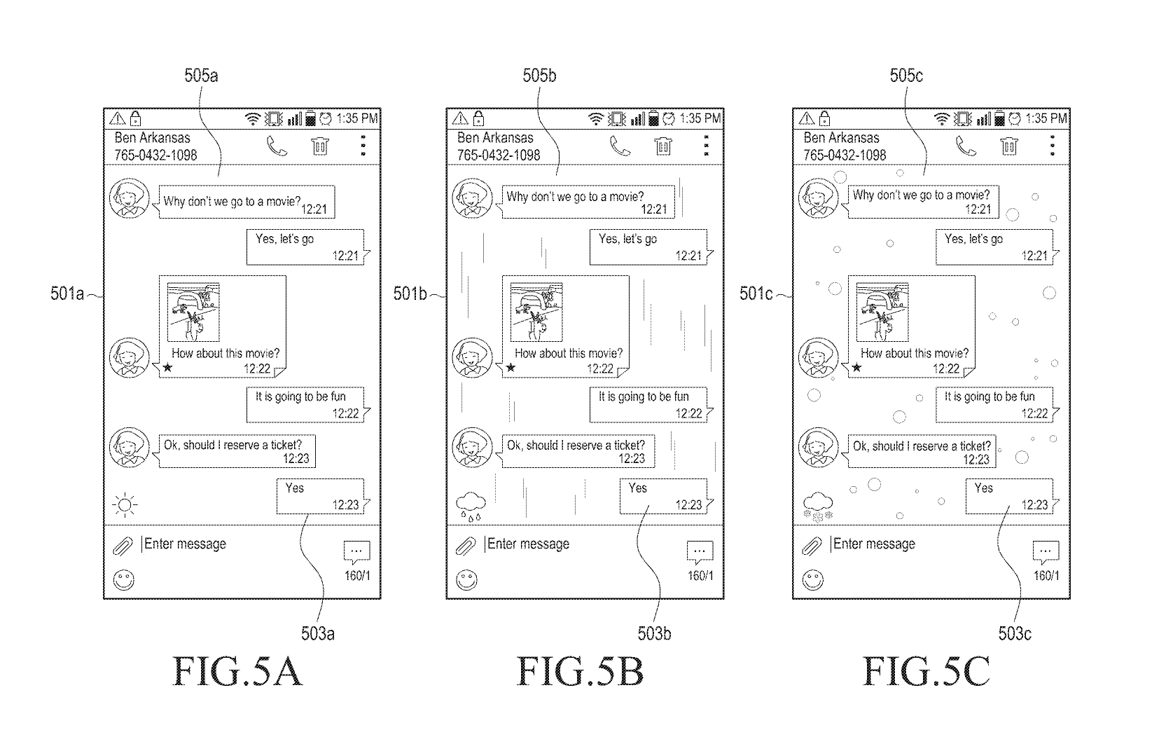

FIGS. 5A to 5C illustrate a message display screen of the electronic device according to various embodiments of the present disclosure.

Referring to FIGS. 5A to 5C, according to various embodiments of the present disclosure, the first electronic device may identify, as context information, weather information at a message communication time or/and a message communication time point of a message 503a, 503b, or 503c selected from one or more message displayed on a message display screen 501a, 501b, or 501c. The first electronic device may collect corresponding contents (for example, at least one of an image, text, and sound information associated with the weather information) from the storage unit or an external device (for example, the server 207 or the information providing apparatus 209 of FIG. 2) based on the identified time or weather information. According to various embodiments of the present disclosure, when the context information corresponds to weather information (weather) and the weather information indicates rain, the collected contents may include at least one information of the image, text, and sound indicating rain.

The first electronic device may generate background information based on the collected contents and apply the generated background information to a background of the message display screen 501a, 501b, or 501c. According to various embodiments of the present disclosure, when context information corresponds to weather information indicating weather and the weather information indicates clear skies as illustrated in FIG. 5A, the first electronic device may generate a background image 505a indicating clear skies based on contents associated with clear skies as the background information, change the background information to the generated background information, and display the changed background information. According to various embodiments of the present disclosure, when the context information corresponds to rain as illustrated in FIG. 5B, the first electronic device may display a rainy background image 505b. According to various embodiments of the present disclosure, when the context information corresponds to snow as illustrated in FIG. 5C, the first electronic device may display a snowy background image 505c.

According to various embodiments of the present disclosure, when the first electronic device detects a tilt by using, for example, at least one sensor, an element of the generated background information may be changed according to the tilt. For example, as illustrated in FIGS. 5A to 5C, in the background information generated based on the weather information, a raining direction is changed in a tilt direction, and thus it may be expressed to rain in the tilt direction.

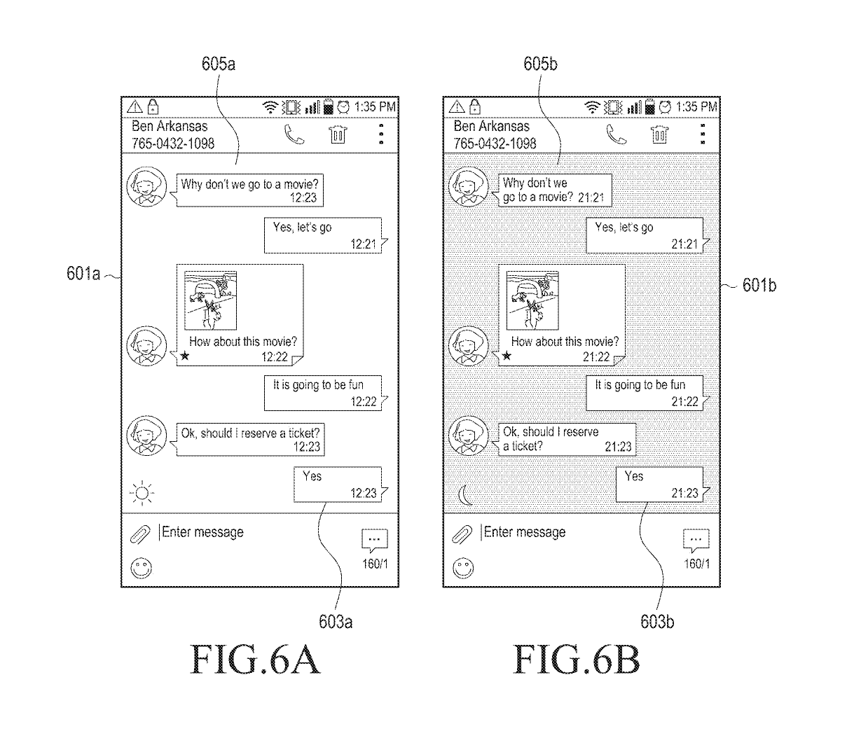

FIGS. 6A and 6B illustrate a message display screen of the electronic device according to various embodiments of the present disclosure.

Referring to FIGS. 6A and 6B, according to various embodiments of the present disclosure, the first electronic device may select at least one message 603a or 603b displayed on a message display screen 601a or 601b and identify a transmission or reception time of at least one selected message 603a or 603b. The first electronic device may identify whether a time point when at least one selected message 603a or 603b is transmitted or received is day or night based on the identified time. The first electronic device may collect contents corresponding to a result of the identification from the storage unit (for example, the storage unit 340 of FIG. 3) or an external device (for example, the server 207 of the information providing apparatus 209 of FIG. 2) and generate background information by using the collected contents. When the generated background information corresponds to day, the first electronic device may display a background image 605a indicating day as illustrated in FIG. 6A. When the generated background information corresponds to night, the first electronic device may display a background image 605b indicating night as illustrated in FIG. 6B. According to various embodiments of the present disclosure, the first electronic device may output, for example, both the background information indicating the time such as night or day and the background information indicating the weather information. According to various embodiments of the present disclosure, the first electronic device may generate the background information by, for example, applying both the time information and the weather information to output weather while showing night or day.

According to various embodiments of the present disclosure, the first electronic device may display the background information as the background image as illustrated in FIGS. 5A, 5B, 5C, 6A and 6B, or change the background information to at least one of a sound, smell, and vibration and output at least one of the sound, smell, and vibration. According to various embodiment of the present disclosure, the first electronic device may change and output a sound (for example, music) corresponding to context information, change and output a smell corresponding to context information, or change and output a vibration corresponding to context information whenever an event is generated (for example, at least one of a time point when a message is transmitted or received and the generation of a user input) while displaying the background image as an initially set background image. According to various embodiments of the present disclosure, when an event is generated, the first electronic device may change and output two or more of an image, video, sound, smell, and vibration or change and output elements different from each other (for example, change a video to a sound).

According to various embodiments of the present disclosure, the first electronic device may generate dynamic background information according to a time change based on a communication time of a plurality of messages and output the generated dynamic background information according to a time change. According to various embodiments of the present disclosure, when the plurality of messages arranged in chronological order are scrolled, the dynamic background information may include an object dynamically moving according to a time change by the scroll.

A method of processing information by an electronic device according to one of the various embodiments of the present disclosure may includes an operation of displaying a message received from an external electronic device by an electronic device, the operation of displaying the message including an operation of presenting first background information in connection with the message, an operation of identifying context information related to the message; an operation of determining second background information based on the context information, and an operation of providing the second background information in connection with the displayed message.

According to various embodiments of the present disclosure, the message may include at least one of a message, a voice, a sound, an email, an image, and a video.

According to various embodiments of the present disclosure, the operation of identifying the context information may include an operation of identifying, as the context information, at least one piece of information of a time, weather, date, temperature, location, and schedule when the message is received or transmitted, user's biometric information, and information contained in the message.

According to various embodiments of the present disclosure, the operation of determining the second background information may include an operation of determining at least one of an image, a video, a sound, a smell, and a vibration as the second background information based on the context information.

According to various embodiments of the present disclosure, when the context information corresponds to an image, the operation of providing the second background information may include an operation of displaying the image to a user through a display functionally connected to the electronic device.

According to various embodiments of the present disclosure, the operation of providing the second background information may include an operation of moving and displaying at least one of the message and the second background information based on a user input.

A method of processing information by an electronic device according to one of the various embodiments of the present disclosure may includes an operation of displaying at least one message on the display screen of a display, an operation of identifying context information related to the at least one message, and an operation of providing background information of a message display area of the display screen based on the identified context information.

According to various embodiments of the present disclosure, the operation of providing the background information of the message display screen may includes an operation of collecting contents corresponding to the identified context information, an operation of generating the background information by using the collected contents; and an operation of providing the generated background information as the background information of the message display area.

According to various embodiments of the present disclosure, the method may further includes an operation of acquiring background information stored in connection with a message moved to and displayed at a preset location of the message display area in response to a user input, and an operation of changing background information currently provided in the message display area to the acquired background information and to provide the changed background information.

According to various embodiments of the present disclosure, the method may further includes an operation of generating background information based on context information identified using information related to a message moved to and displayed at a preset location of the message display area in response to a user input, and an operation of changing the background information of the message display area to the generated background information and providing the changed background information.

According to various embodiments of the present disclosure, the method may further includes an operation of skipping at least one message moved to and displayed in the message display area in response to a user input; an operation of, when there is a particular message in a plurality of messages moved to and displayed in the message display area, generating background information based on the particular message, and an operation of changing the background information of the message display area to the generated background information and providing the changed background information.

According to various embodiments of the present disclosure, the method may further include an operation of changing the background information of the message display area based on at least one message among messages transmitted or received during a predetermined period and providing the changed background information.

According to various embodiments of the present disclosure, the operation of providing the background information of the message display area based on the identified context information may includes an operation of moving and displaying a plurality of messages arranged in the message display area in chronological order in response to a user input, an operation of generating dynamic background information according to a time change based on a communication time of the plurality of messages, and an operation of providing the generated dynamic background information as the background information of the message display area.

According to various embodiments of the present disclosure, the method may further include an operation of displaying background information for another user in one area of a screen of a display unit to be separated from the message display area.

According to various embodiments of the present disclosure, the method may further include an operation of changing the background information of the message display area to background information for another user and providing the changed background information.

According to various embodiments of the present disclosure, the method may further include an operation of moving and displaying at least one of the message displayed in the message display area and the background information based on a user input.

According to various embodiments of the present disclosure, the background information of the message display area may include at least one of an image, a video, a sound, a smell, and a vibration, generated using collected contents in accordance with the context information.

Various embodiments of the present disclosure will be described in detail with reference to the accompanying drawings based on the configuration of the electronic device and the operation for processing information as described above.

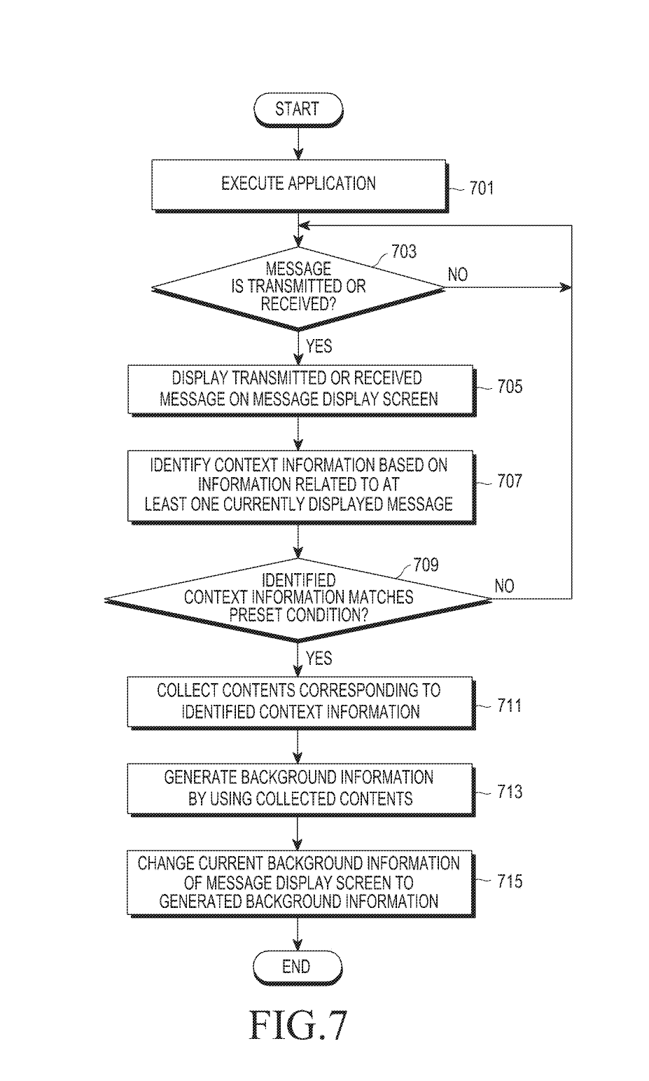

FIG. 7 illustrates an operation process of the electronic device according to various embodiments of the present disclosure.

Referring to FIG. 7, according to various embodiments of the present disclosure, in operation 701, the first electronic device (for example, the electronic device 101 of FIG. 1 or the electronic device 201 of FIG. 2) may initiate, for example, execution of an application (or function) for transmitting/receiving a message. According to various embodiments of the present disclosure, when there is no transmitted/received message, that is, in a state of standing by for message transmission/reception after the execution of the application (or function), the first electronic device may output initially set background information (for example, a background image) or previously changed background information in the message display area. According to various embodiments of the present disclosure, when there is a message previously transmitted/received to/from the second electronic device, the first electronic device may display the previously transmitted/received message in the message display area, and output the initially set background information or the previously changed background information as the background of the message display area. According to various embodiments of the present disclosure, when the execution of the application or function for message communication starts, the first electronic device may output background information generated based on context information at a current time point as the background of the message display screen. The generated background information may be generated according to currently identified context information without being based on the message displayed on the message display screen. The first electronic device may identify, for example, time information at a time point when the execution of the application or function starts and, when the identified time corresponds to day, output background information indicating day. Further, the first electronic device may identify, for example, weather information at a time point when the execution of the application or function starts and, when the identified weather information corresponds to rain, output rainy background information. When the application (or function) related to the message communication is executed, the first electronic device may stand by to perform the message communication with the second electronic device (for example, the electronic device 102 or 104 of FIG. 1 or the electronic device 203 of FIG. 2).

In operation 703, the first electronic device may identify whether a message is transmitted or received. When the message is transmitted or received, the first electronic device may perform operation 705. When the message is not transmitted or received, the first electronic device may perform operation 703.

In operation 705, the first electronic device may display the transmitted or received message in one area (for example, message display area) of the executed message display area. A plurality of transmitted or received messages may be displayed while being arranged in a preset direction (for example, from top to bottom, from bottom to top, from left to right, or from right to left) in chronological order, and may be displayed while moving in an input direction whenever a new message is generated or a user input (for example, scroll) is generated.

In operation 707, the first electronic device may identify context information related to at least one message displayed in the current message display area and store the identified context information. According to various embodiments of the present disclosure, the first electronic device may identify, as context information, at least one piece of temporal information (at least one of a communication time, date, day of the week, month, and year) of at least one message, configuration information (for example, configured theme), information included in the message, user information (for example, biometric information), a particular mark (for example, bookmark), weather information, region information, surrounding environment information, and location information.

According to various embodiments of the present disclosure, when the background of the message display area is configured to display, for example, weather, the first electronic device may identify, as context information, weather information collected and pre-stored according to settings through an application or weather information received through communication with an external device (for example, the server 106 of FIG. 1, the server 207 of FIG. 2, or the information providing apparatus 209 of FIG. 2).

In operation 709, the first electronic device may identify whether the identified context information matches a preset condition. When the identified information matches the preset condition, the first electronic device may perform operation 711. When the identified information does not match the preset condition, the first electronic device may perform operation 703. According to various embodiments of the present disclosure, the first electronic device may configure the preset condition to identify, for example, whether to change background information, whether the identified information corresponds to a time interval configured to change background information, or whether the identified information is information corresponding to a configured theme.

In operation 711, the first electronic device may collect contents corresponding to the identified context information. According to various embodiments of the present disclosure, the first electronic device may collect corresponding contents from the storage unit (for example, the storage unit 340 of FIG. 3) or collect corresponding contents from the external device (for example, the server 106 of FIG. 1, the server 207 of FIG. 2, or the information providing apparatus 209 of FIG. 2). According to various embodiments of the present disclosure, the first electronic device may acquire, for example, weather information of a particular schedule (for example, at least one of a time point when a message is transmitted or received, a configured time interval, and a user request time point) based on the context information identified in operation 707, and acquire, as contents, at least one of an image, sound, vibration, and smell data file related to the corresponding weather information through the server 207.

In operation 713, the first electronic device may generate background information by using the collected contents. The background information may be generated as at least one of an image, sound, video, vibration, and smell. According to various embodiments of the present disclosure, when the first electronic device acquires, as the contents, a snowy image based on, for example, weather information indicating snow, the first electronic device may process (for example, at least one of enlarge, reduce, combine, and correct) the snowy image to be a background image that fits a background layer of the message display screen or generate the snowy image as the background image without any change.

In operation 715, the first electronic device may change the background information currently displayed on the message display screen to the generated background information and output the changed background information. According to various embodiments of the present disclosure, the first electronic device may display the changed background information to be separated from the layer including transmitted/received messages on the message display screen (for example, display the changed background information as a lower layer (background layer) of the background of the transmitted/received messages, that is, the layer including the transmitted/received messages).

As illustrated in FIG. 7, when an event for transmitting or receiving messages according to various embodiments of the present disclosure is generated, an operation for changing the background information on the message display screen will be described in more detail with reference to the drawings below.

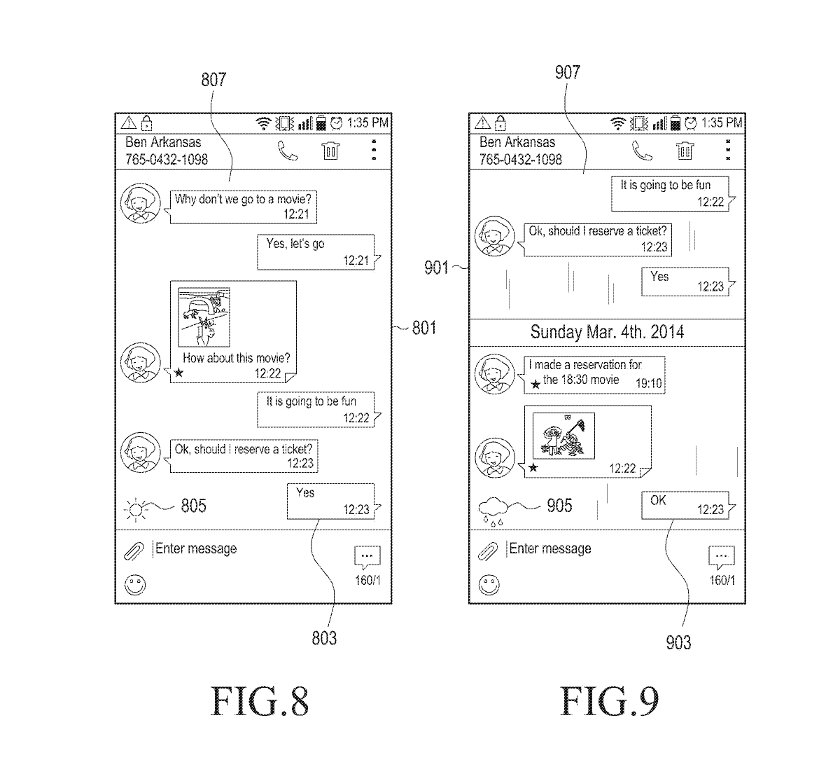

FIGS. 8, 9, 10, 11, 12, 13A, 13B, 14A, 14B, 15A, 15B, 15C, 16A, 16B, and 16C illustrate the message display screen of the electronic device according to various embodiments of the present disclosure.

Referring to FIGS. 8 and 9, according to various embodiments of the present disclosure, the first electronic device may display the message display screen according to execution of an application (or function) related to message communication and display messages transmitted/received through the message communication in a message display area 801 or 901 of the message display screen. The first electronic device may select at least one message 803 or 903 (for example, most recently transmitted or received message) displayed in the message display area and identify context information (for example, weather information) corresponding to at least one selected message. When the identified context information corresponds to, for example, weather information indicating clear skies, the first electronic device may collect contents corresponding to the weather information indicating clear skies and generate background information 807 (for example, a background image) indicating clear skies by using the collected contents. When the identified context information corresponds to, for example, weather information indicating rain, the first electronic device may collect contents corresponding to the weather information indicating rain and generate background information 907 (for example, a background image) indicating rain by using the collected contents.

The first electronic device may reflect the generated background information 807 or 907 to the background of the message display area to output the clear skies background information 807 or rain background information 907 as the background of the message display area. According to various embodiments of the present disclosure, the first electronic device may display, in one area of the application related to the message communication, a widget 805 indicating clear skies by using the background information 807 generated as the background of the message display area and a widget 905 indicating rain by using the background information 907 generated as the background of the message display area.

According to various embodiments of the present disclosure, the first electronic device may output at least one of background information indicating day and background information indicating night, which are generated based on context information on the time as the background of the message display area 801 or 901 through the same operation as that in FIGS. 8 and 9. According to various embodiments of the present disclosure, the first electronic device may generate background information by combining, for example, contents indicating day and contents indicating clear skies based on weather information and time information and simultaneously output the generated background information indicating day and clear skies as the background of the message display screen.

According to various embodiments of the present disclosure, when changing background information, the first electronic device may slowly change the previous background information (for example, previous background image) to the generated background information to express the change naturally. According to various embodiments of the present disclosure, the first electronic device may display the generated background information to have, for example, an effect of the rising sun at a moment when night changes to day. According to various embodiments of the present disclosure, when changing background information, the first electronic device may control a brightness of the message display area to make the previous background image slowly transparent and the background image to be changed slowly opaque. That is, the first electronic device may slowly change two background images by sequentially controlling transparency values of the two layers of the previous background image and the background image to be changed.

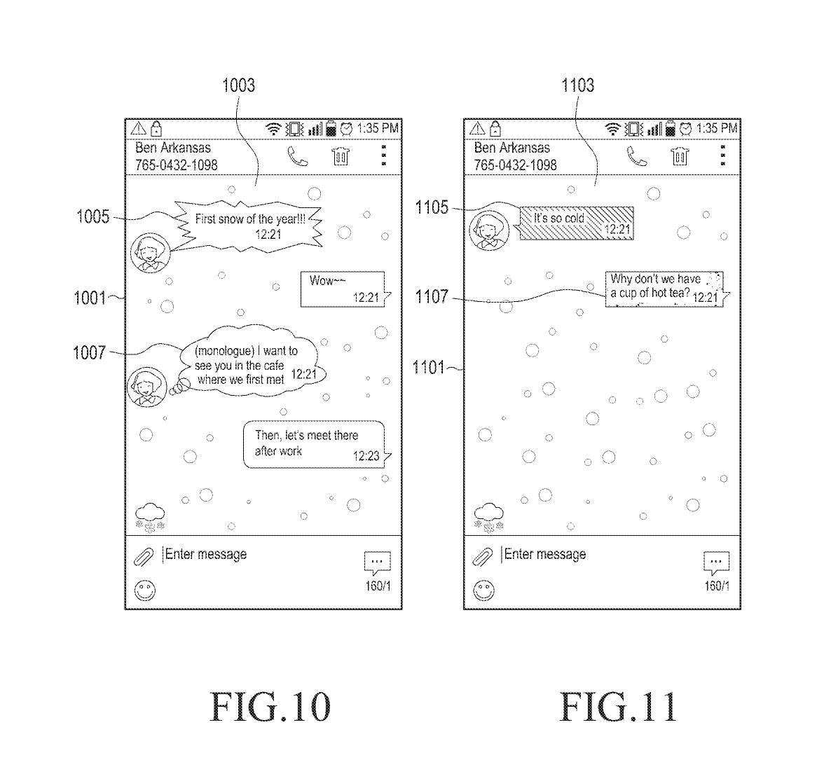

Referring to FIG. 10, according to various embodiments of the present disclosure, the first electronic device may change and output background information or a message form according to user's context (for example, surrounding environment or emotional state). The information (user context information) indicating a user's context may be acquired using at least one piece of biometric information received from an external device (for example, the wearable device 205 of FIG. 3), user input information, and information included in the messages. According to various embodiments of the present disclosure, the first electronic device may change, for example, a background color of the message display area or output corresponding contents (at least one an image, video, sound, smell, and vibration, or a combination thereof) as the background of the message display area based on user context information acquired at a time point when the message is transmitted or received. As illustrated in FIG. 10, according to various embodiments of the present disclosure, the first electronic device may analyze at least one message displayed in a message display area 1001, grasp context information according to a result of the analysis, and output generated background information 1003 as the background of the message display screen according to the grasped context information. According to various embodiments of the present disclosure, the first electronic device may grasp context information by recognizing, for example, an interjection such as “First snow of the year!!” or context in the displayed message and change at least some of the background information 1003 displayed on the current message display screen based on background information generated based on the grasped context information. For example, when the message includes the interjection such as “First snow of the year!!” or includes contents of exclamation based on context, the first electronic device may display a speech bubble 1005 including the message or display a speech bubble 1007 according to contents of the message.

Referring to FIG. 11, according to various embodiments of the present disclosure, the first electronic device may change and output background information 1103 based on context information (for example, surrounding environment or emotional state) grasped based on a color of a message 1105 or 1107 displayed in a message display area 1101 as illustrated in FIG. 11.

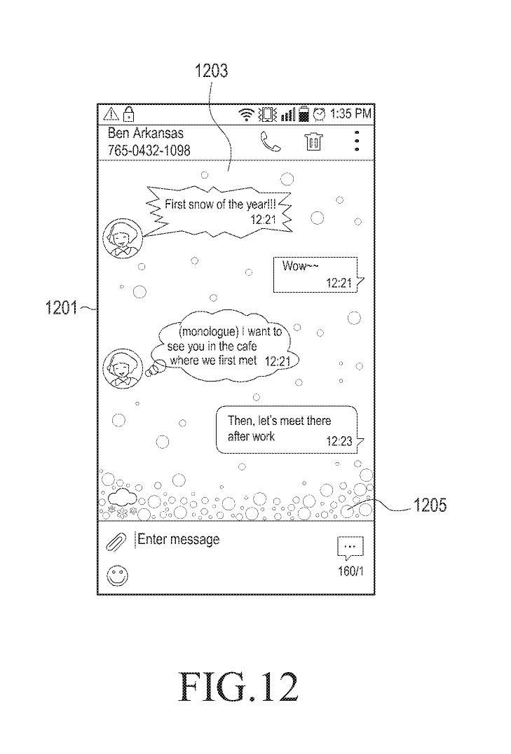

Referring to FIG. 12, according to various embodiments of the present disclosure, the first electronic device may change background information 1203 displayed as a background of a message display area 1201 as time passes. According to various embodiments of the present disclosure, the first electronic device may update and output background information 1205 indicating an accumulation of snow or collection of rain at an edge of a message display area 1201 as time passes.

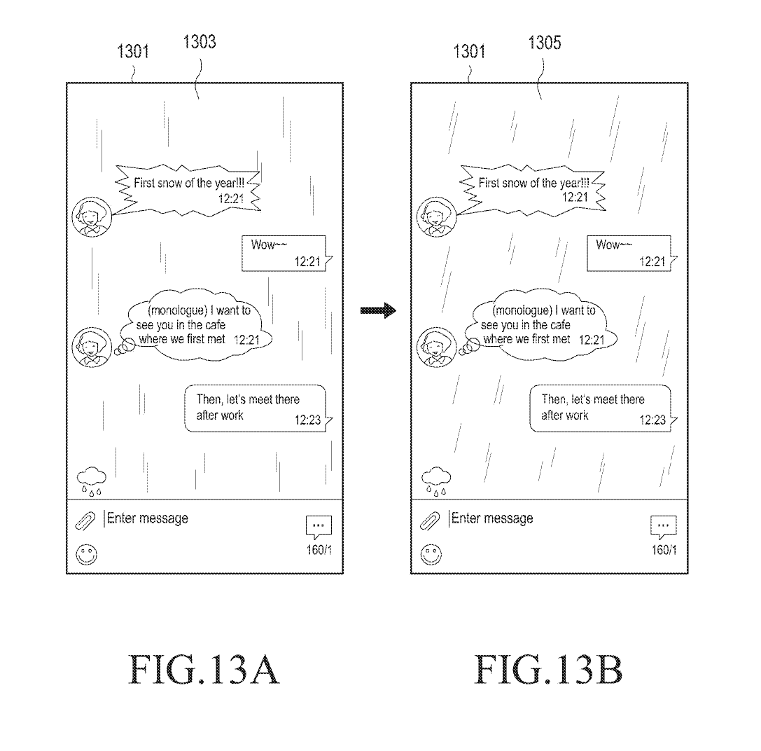

Referring to FIGS. 13A and 13B, according to various embodiments of the present disclosure, the first electronic device may change background information 1303 displayed on a message display screen 1301 based on information detected through at least one sensor (for example, a tilt sensor). According to various embodiments of the present disclosure, the first electronic device may detect, for example, a direction of a user's gesture (for example, an action of moving his/her hand from side to side) and make an object of the background information move in the detected direction. According to various embodiments of the present disclosure, the first electronic device may change previous background information 1303 to background information 1305 in which a rain direction is changed in a tilt direction or tilted direction according to tilt information (direction or tilt degree) detected through, for example, the tilt sensor and output the changed background information 1305.

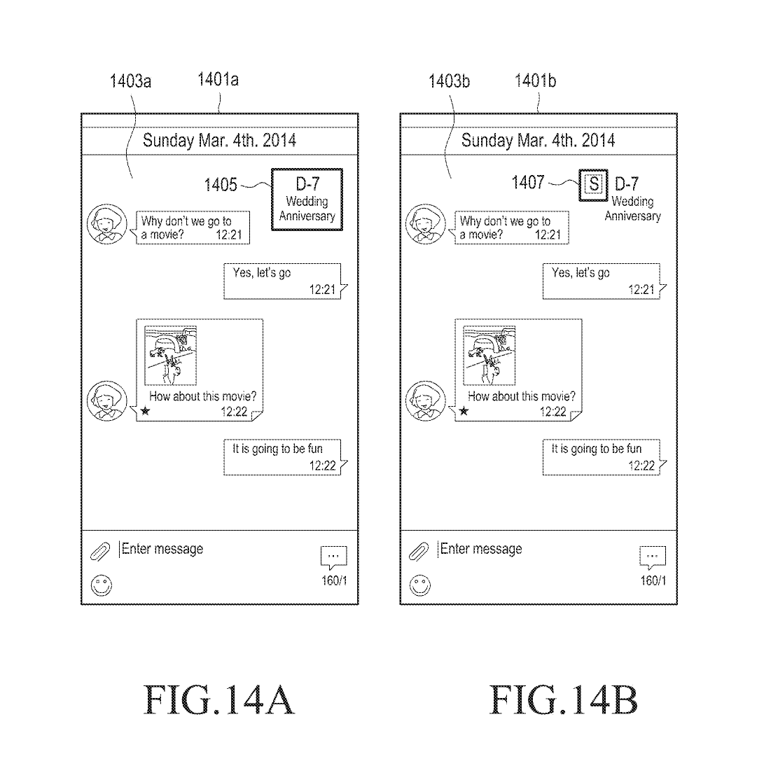

Referring to FIGS. 14A and 14B, according to various embodiments of the present disclosure, the first electronic device may identify context information (for example, a message transmission/reception time) related to at least one message displayed in a message display area 1401a or 1401b and display, as background information, user's schedule information 1405 stored through another application (for example, a scheduler, calendar, or note pad) as contents corresponding to the identified context information. According to various embodiments of the present disclosure, the first electronic device may also display the schedule information 1405 or a button or a widget 1407, which can be linked with another application, in at least a part of a background image 1403a or 1403b of the message display area 1401a or 1401b. For example, the widget 1407 may be linked with a schedule application. When the user selects the widget 1407 in the background, the schedule application may be executed.

According to various embodiments of the present disclosure, the first electronic device may move and display messages in a scroll direction on a message display screen 1401 so that previously transmitted/received messages can be shown in response to a user's scroll operation input. The first electronic device may output, as background information, contents (for example, the schedule information 1405 (for example, d-day (D-7)) corresponding to context information related to at least one message on the current message display screen 1401 in response to a user's scroll operation input. According to various embodiments of the present disclosure, when messages transmitted/received the previous day are displayed on the message display screen according to a scroll operation, the schedule information 1405 may be updated and output as a schedule of the previous day (for example, d-day (D-9)).

According to various embodiments of the present disclosure, the first electronic device may identify context information (for example, at least one piece of information on message transmission/reception time, information contained in the message, and user context information (surrounding environment or emotional state) related to at least one message displayed in the message display area and output, as background information, a sound (for example, a sound source) as contents corresponding to the identified context information. According to various embodiments of the present disclosure, the first electronic device may change and output a sound whenever an event is generated and also change and output a smell or a vibration. According to various embodiments of the present disclosure, when the content information currently corresponds to night based on the information on the message transmission/reception time contained in the identified context information, the first electronic device may generate, as the background information, a background image indicating night and/or quiet music pleasing to hear at night, and output the generated background information.

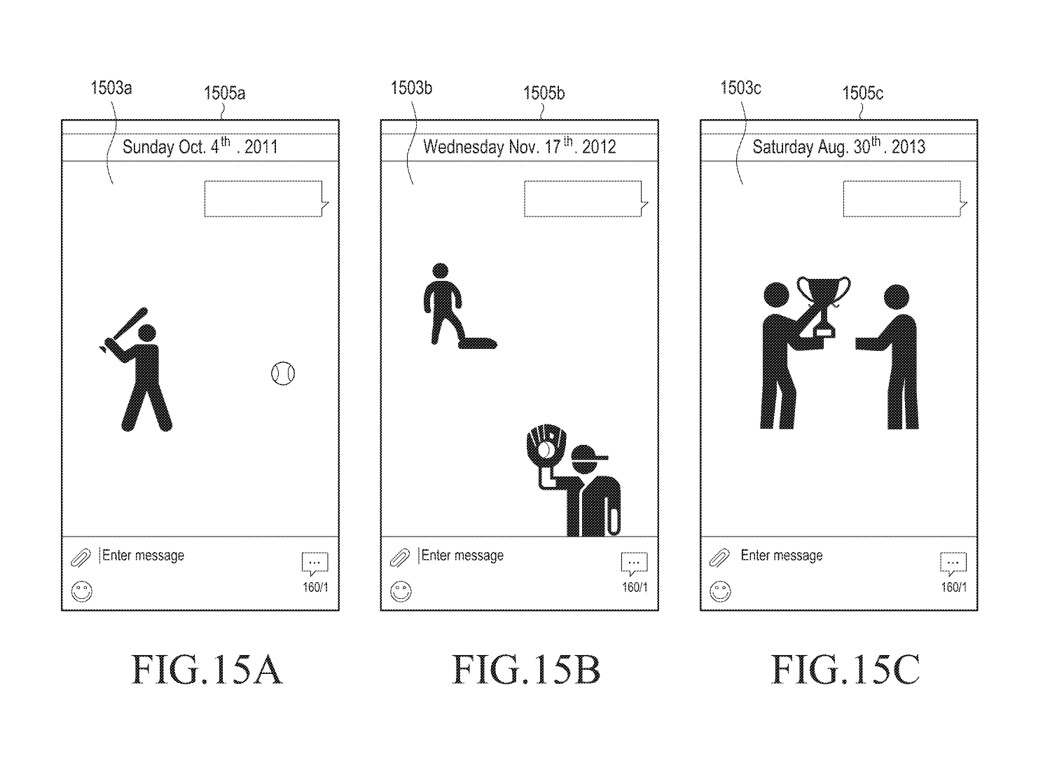

Referring to FIGS. 15A to 15C, the first electronic device may configure a predetermined time zone and output contents corresponding to a preset theme according to each configured time zone as the background information. According to various embodiments of the present disclosure, the first electronic device may configure a particular theme on a preset time period (in the unit of at least one of time, day, week, month, year, and season) and output the configured theme on the preset time period. According to various embodiments of the present disclosure, the first electronic device may output, for example, a particular theme according to year (for example, 12-year cycle of the Chinese zodiac, Olympic Games, sports event, or car according to year) as the background information. For example, when a particular theme (for example, baseball) related to a user's hobby is configured, the first electronic device may generate background information by using contents related to a baseball series provided according to each preset time period (for example, each year), and display, as the background information, the contents related to the baseball series in the message display area based on identified context information 1505a, 1505b, or 1505c (for example, time (each year)) as illustrated in FIGS. 15A, 15B, and 15C. According to various embodiments of the present disclosure, the first electronic device may output, as the background information 1503a, a main context of the baseball series (for example, game highlights of teams A and B in the regular season) at the identified time point (for example, 2011) as illustrated in FIG. 15A, output, as the background information 1503b, main context (for example, game highlights of a playoff game) at the identified time point (for example, 2012) as illustrated in FIG. 15B, and output, as the background information 1503c, main context (for example, a scene of receiving the most valuable player (MVP) award of the game) at the identified time point (for example, 2013) as illustrated in FIG. 15C.

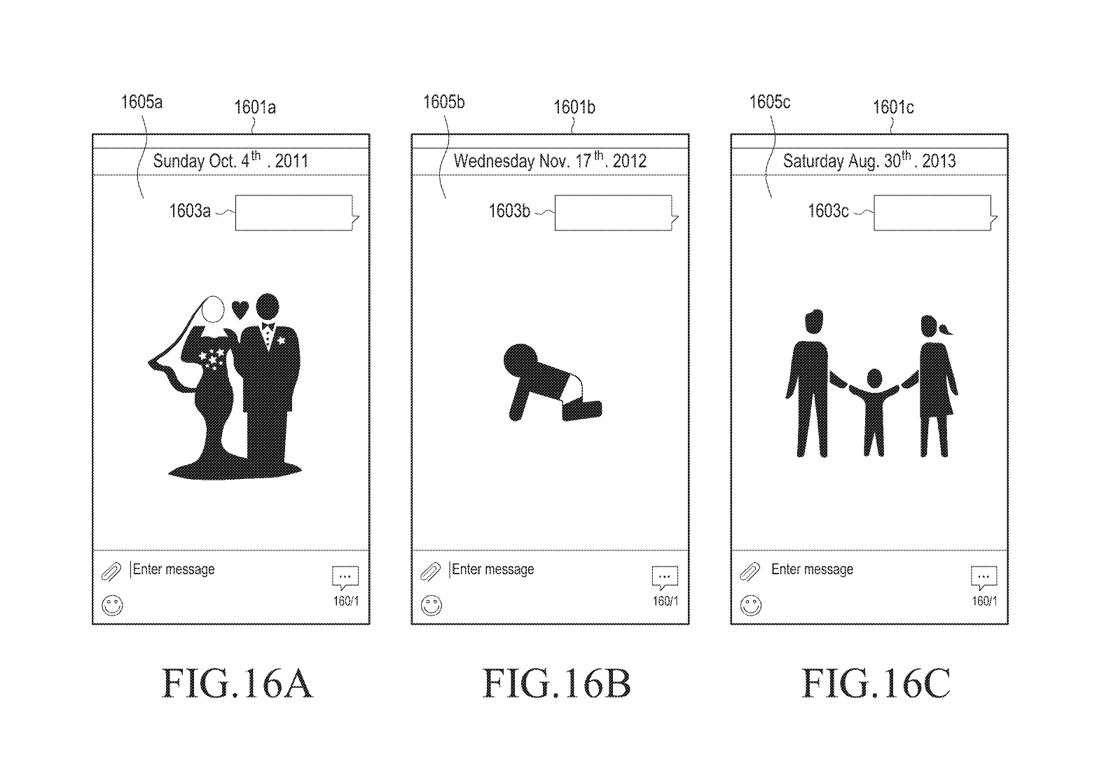

Referring to FIGS. 16A to 16C, according to various embodiments of the present disclosure, the first electronic device may configure a user's theme-specific item (for example, an item in at least one area of interest among family, car, and travel) as a condition for generating background information. Further, the first electronic device may identify an event for changing background information, for example, a transmission/reception time point of at least one message 1603a, 1603b, or 1603c displayed on a currently shown message display screen 1601a, 1601b, or 1601c. When the user's theme-specific item is identified in connection with the identified time point, the first electronic device may collect corresponding contents (for example, at least one of a photo, video, and sound related to the user's family) according to the identified theme-specific item, generate background information 1605a, 1605b, or 1605c to be applied as a background of the currently shown message display screen 1601a, 1601b, or 1601c by using the collected contents, and display the generated background information 1605a, 1605b, or 1605c on the message display screen 1601a, 1601b, or 1601c. According to various embodiments of the present disclosure, the first electronic device may identify a transmission or reception time point of at least one message in the currently displayed message display area and generate, for example, a photo taken at a time point corresponding to the identified time point among photos of the configured theme as the background information. The first electronic device may output at least one wedding photo in connection with the identified time point (2011) (for example, a wedding time point) as the background information 1605a as illustrated in FIG. 16A, output at least one baby photo in connection with the identified birth time point (2012) as the background information 1605b as illustrated in FIG. 16B, and output at least one family photo taken at the time point corresponding to the identified time point (2013) as the background information 1605c as illustrated in FIG. 16C.

As illustrated in FIGS. 8, 9, 10, 11, 12, 13A, 13B, 14A, 14B, 15A, 15B, 15C, 16A, 16B, and 16C, according to various embodiments of the present disclosure, the first electronic device may pre-configure a theme of contents for generating background information in order to change the background information of the message communication-related application. According to various embodiments of the present disclosure, the first electronic device may provide a screen for configuring a theme of contents for generating the background information. For example, when a theme item provided on a configuration screen is selected by the user, the first electronic device may display a detailed item for the theme which can be selected (for example, at least one of weather, gallery, hobby, and animal) and configure the detailed item selected by the user as the theme for generating the background information.

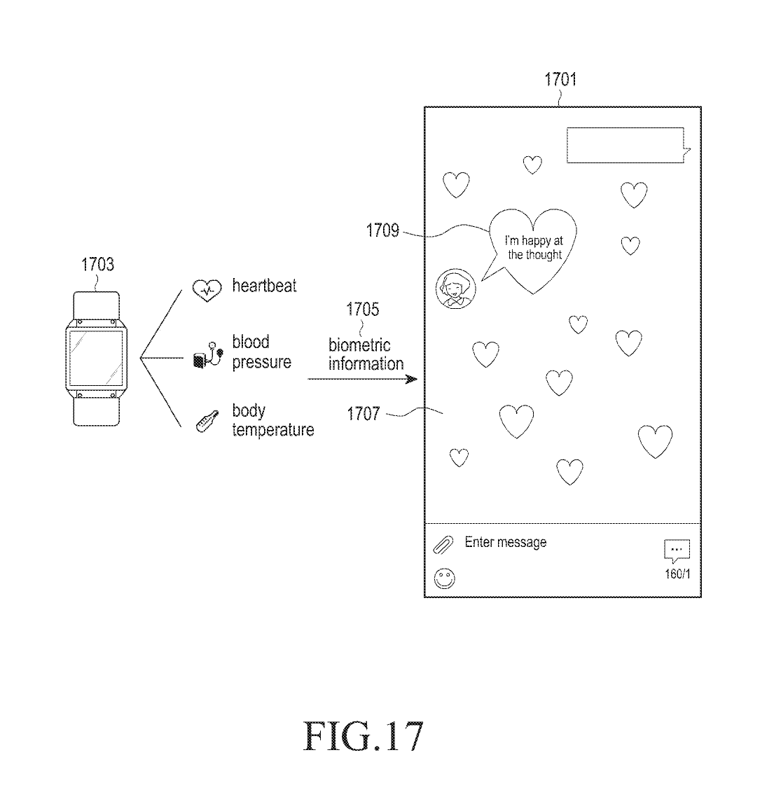

FIG. 17 illustrates a message display screen of the electronic device according to various embodiments of the present disclosure.

Referring to FIG. 17, according to various embodiments of the present disclosure, the first electronic device may identify context information (for example, at least one of a user's emotional state, health state, and surrounding environment state) related to the user at a time point when at least one message displayed on a current message display screen or area 1701 is transmitted or received. According to various embodiments of the present disclosure, as illustrated in FIG. 17, the first electronic device may receive biometric information 1705 from an external device 1703 (for example, wearable device), analyze the received biometric information 1705, and identify that currently the user is in a happy state as the context information. The biometric information may correspond to a user's biometric information detected by the wearable device 1703 or at least one internal sensor and may be, for example, at least one piece of information among a user's heartbeat, blood pressure, body temperature and voice. Further, the first electronic device may collect contents (for example, at least one of an image, video, sound, vibration, and smell) corresponding to the identified context information, generate background information 1707 to be output as a background of a message display area 1701 by using the collected contents, and output the background information 1707 indicating happiness as the background of the message display area 1701. In addition, the first electronic device may change a display form of at least one message to a heart shape 1709 representing happiness. Information on the message display form may be generated while being included in the background information or may be generated as additional information which can be output while being separated from the background information according to a function of the electronic device or application.

When an event based on user input information according to various embodiments of the present disclosure is generated, an operation for changing the background information of the message display screen will be described in more detail with reference to the drawings below.

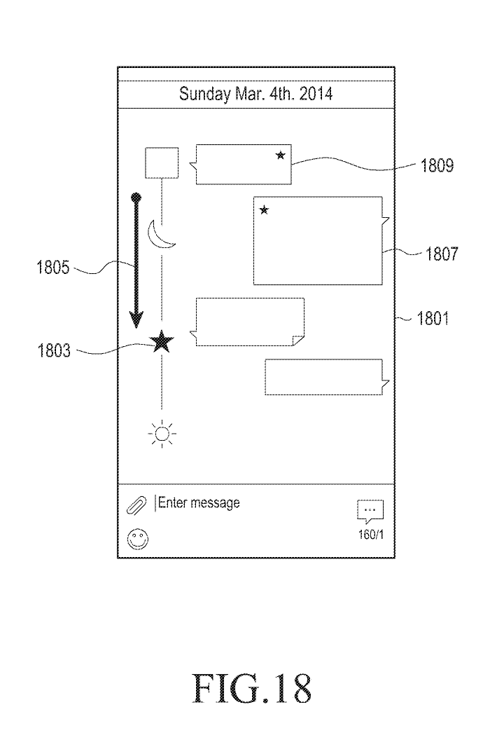

FIGS. 18 to 20, 21A and 21B, 22A to 22C illustrate a message display screen of the electronic device according to various embodiments of the present disclosure.

Referring to FIG. 18, according to various embodiments of the present disclosure, the first electronic device may move and display messages displayed in a message display area 1801 in chronological order in a user input (for example, scroll) direction in response to user input information (for example, a user's scroll operation input). The first electronic device may change a background shown on the current message display screen according to a scroll operation 1805. According to various embodiments of the present disclosure, the first electronic device may display background information indicating, for example, clear skies before the scroll operation and then display background information (for example, background information indicating night) generated based on at least one message shown on the message display screen in response to an input of the scroll operation. Further, when the scroll operation is continuously input, the first electronic device may continuously change background information generated based on at least one message currently shown on the message display screen while moving in a scroll operation direction, so that background information, which is continuously changed according to the scroll operation, may be output. According to various embodiments of the present disclosure, information (for example, at least one of an icon, emoticon, and thumbnail image)(1803) indicating background information, which is changed according to the scroll operation, may be sequentially displayed in one area of the message display screen. According to various embodiments of the present disclosure, when a message 1807 or 1809 with a particular mark (for example, bookmark) of FIG. 18 is located in a preset area (for example, center area of the message display screen), the first electronic device may output background information (for example, background information indicating night or a photo of the configured theme) generated using contents collected based on context information of the message 1807 or 1809 as the background of the message display screen.

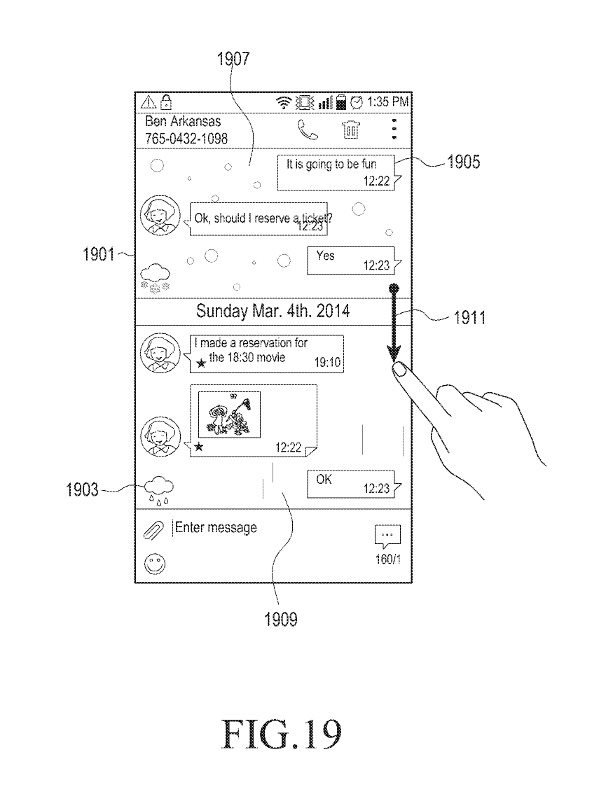

Referring to FIG. 19, according to various embodiments of the present disclosure, the first electronic device may divide the background of the currently shown message display screen into two or more areas and display different pieces of background information in the divided areas 1901 and 1903. The first electronic device may display background information 1907 (for example, background information indicating snowing) generated based on a message 1905, which is displayed in a preset area of the message display area, in the first divided area 1901. Further, when messages displayed in the first divided area 1901 are moved in a movement direction by a scroll operation 1911, the first electronic device may apply background information 1909, which was previously displayed in the first divided area 1901, to the second divided area 1903 and output the background information 1909 as the background of the second divided area 1903. According to various embodiments of the present disclosure, the divided areas may be divided in a predetermined size and formed in a fixed size. According to various embodiments of the present disclosure, the divided areas are divided to separately display the previous background information and the currently generated background information, for example, when an event is generated or when a date is changed, and the size of the area shown on the message display screen may be changed while moving in the movement direction according to the scroll operation 1911. For example, when the message 1905 moves in a down direction according to the scroll operation 1911 as illustrated in FIG. 19, the size of the first divided area 1901 may be larger in the down direction, so that the first electronic device may enlarge and display the background information 1907 or additionally display the background information 1907. Further, the size of the second divided area 1903 located in a lower area may be smaller, so that the first electronic device may reduce and display the background information 1909 and display only a part of the background information 1909.

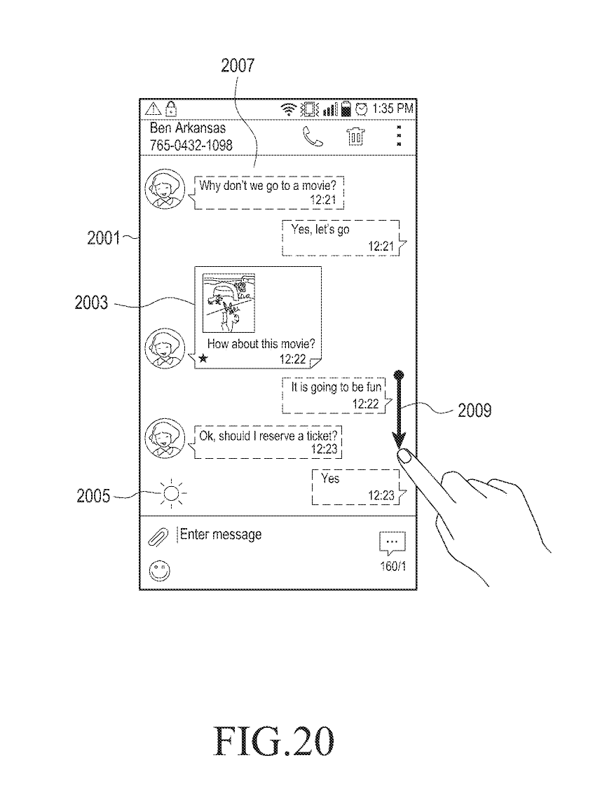

Referring to FIG. 20, the first electronic device may move and display messages displayed in a message display area 2001 in a scroll direction in response to a user's scroll operation input 2009, and skip some messages (within dotted line boxes), which should be shown at the current scroll location of the message display area 2001, according to a scroll speed (for example, in a fast scroll). According to various embodiments of the present disclosure, when there is a message with a particular mark, the first electronic device may display a message 2003 in the message display area 2001 to allow the user to identify and not skip the message 2003 with the particular mark (for example, bookmark) as illustrated in FIG. 20. According to various embodiments of the present disclosure, in the fast scroll operation, the first electronic device may configure a layer for displaying background information, a layer for displaying skipped messages, and a layer for displaying a particular message, which is not skipped, and display the configured layers on the message display screen. According to various embodiments of the present disclosure, the first electronic device may generate background information 2007 based on at least one message 2003, which is not skipped, in the message display area 2001. The first electronic device may output the generated background information 2007 as a background of the message display screen 2001. Further, the first electronic device may output a widget 2005 corresponding to the background information in one area of the message display screen. According to various embodiments of the present disclosure, when context information related to at least one message 2003 selected from the currently displayed message display screen 2001 corresponds to, for example, clear skies, the first electronic device may output the background information 2007 generated using contents corresponding to clear skies. At least one selected message 2003 corresponds to a reference message according to a preset condition, and may be automatically selected by the first electronic device according to the preset condition. Since messages are changed in response to the user's scroll operation input 2009, the reference message may be also changed in response to the user's scroll operation input 2009. The preset condition may include at least one of, for example, a particular mark, a multimedia message, a message received from a particular user, a message transmitted/received at a particular time, a message displaying an image, and a message containing a particular word. The first electronic device may automatically change the background of the screen displayed according to the scroll based on context information of the reference message automatically selected according to the scroll. According to various embodiments of the present disclosure, when selecting at least one message on the current message display screen 2001, the first electronic device may select a currently displayed and most recently received message or a message with a particular mark.

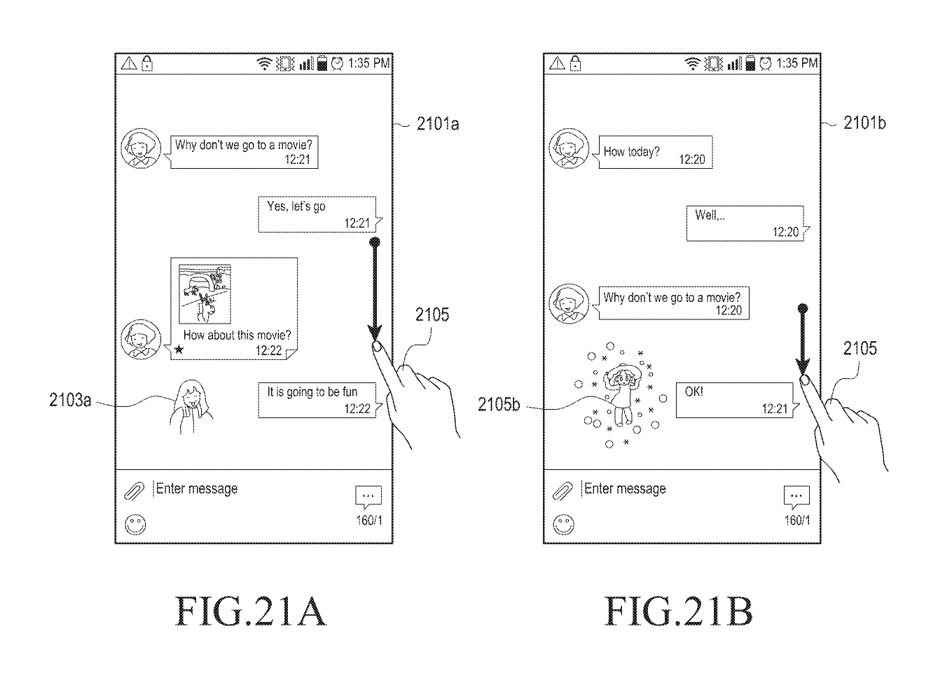

Referring to FIGS. 21A and 21B, according to various embodiments of the present disclosure, the first electronic device may configure contents (for example, MEME) having fun elements as the theme of the background information. The first electronic device may identify context information related to at least one message displayed on a message display screen 2101a and generate background information 2103a by using contents having a fun element corresponding to the identified context information according to the configured theme. For example, when the configured theme corresponds to the fun element, the first electronic device may identify the fun element currently configured by the user or a message transmission/reception time and output background information including contents corresponding to the fun element configured at the identified time as a background of the message display screen 2101a. When messages are moved and displayed in response to a user's scroll operation input 2105 as illustrated in FIG. 21B, the first electronic device may output background information 2105b including contents having a fun element configured at a transmission/reception time of at least one message displayed on the currently shown message display screen 2101b as a background of the message display screen 2101b.

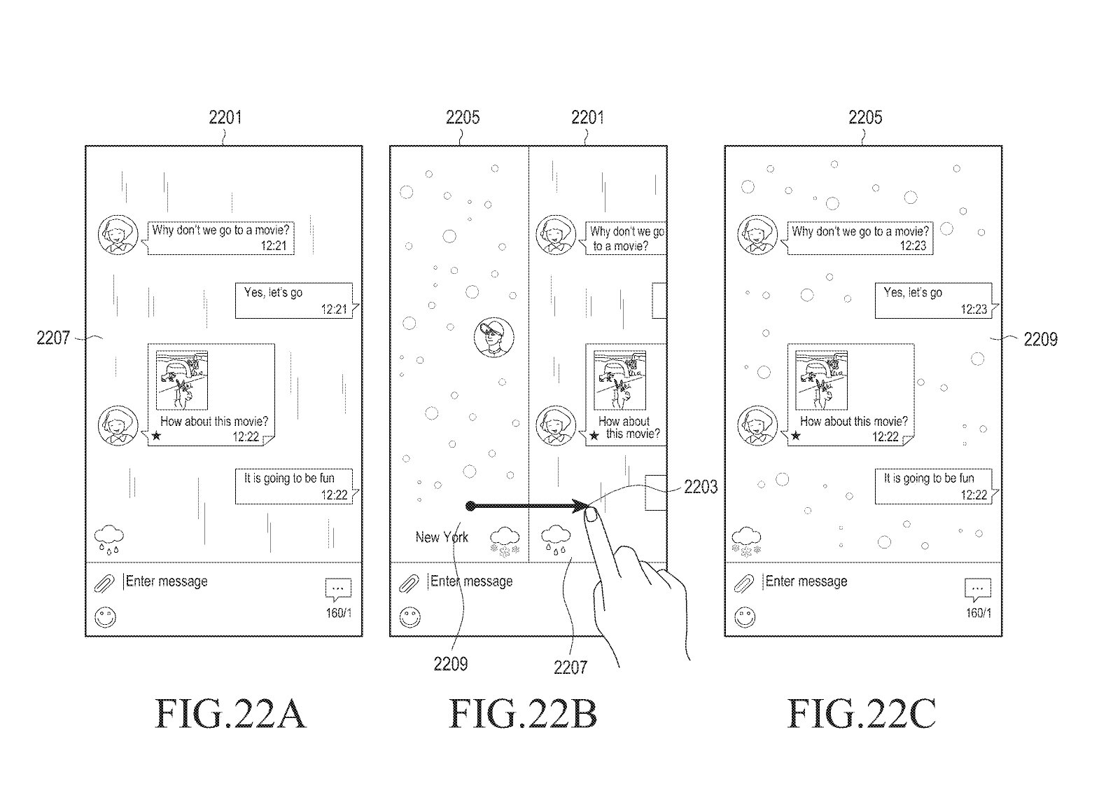

Referring to FIGS. 22A to 22C, according to various embodiments of the present disclosure, the first electronic device may output background information (for example, background information indicating raining) 2207 generated based on information related to at least one message displayed as a background of a current message display area 2201 as a background of the message display screen. When a particular gesture 2203 for viewing counterpart information is input by the user in the message display area 2201 of the message display screen, the first electronic device may receive counterpart context information or counterpart background information from the counterpart, that is, a second terminal device. The first electronic device may generate counterpart background information by using the received context information and output the generated background information or the received background information as a background of a counterpart information viewing area 2205 divided and displayed on the message display screen 2201.

The first electronic device may display counterpart background information 2209 in the counterpart information viewing area 2205 and, when a location of the gesture input passes by a particular threshold location, output the counterpart background information 2209 as the background of its own message display area 2201. The background information 2007 and 2009 may be generated according to a change in context information identified in messages scrolled in response to a scroll operation input by the user and may displayed seamlessly. According to various embodiments of the present disclosure, the first electronic device may identify context information on the corresponding user by selecting and dragging information on users (for example, profile photo images) who participate in a conversation in a group chat, and generate background information of the corresponding user by using the identified context information. According to various embodiments of the present disclosure, when receiving a message from the corresponding user, the first electronic device may change the generated background information to be the background of the current message display screen and display the changed background information or combine and display the generated background information in some areas of the current message display screen. According to various embodiments of the present disclosure, the first electronic device may divide the message display screen according to the user and display the generated background information as a background of a divided area of the corresponding user.

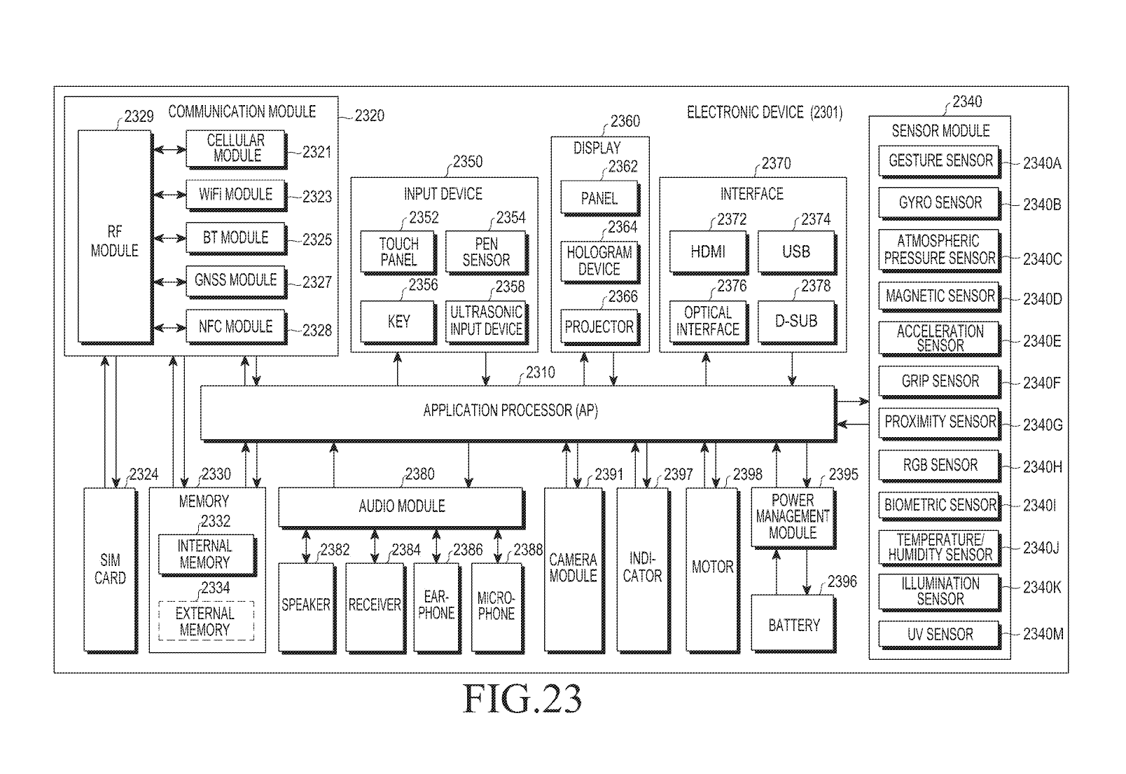

FIG. 23 is a block diagram illustrating an electronic device 2301 according to various embodiments of the present disclosure. The electronic device 2301 may include, for example, the whole or a part of the electronic device 101 illustrated in FIG. 1. The electronic device 2301 may include at least one AP 2310, a communication module 2320, a subscriber identification module (SIM) 2324, a memory 2330, a sensor module 2340, an input device 2350, a display 2360, an interface 2370, an audio module 2380, a camera module 2391, a power management module 2395, a battery 2396, an indicator 2397, and a motor 2398.

Referring to FIG. 23, the processor 2310 may control a plurality of hardware or software components connected to the processor 2310 by driving an OS or an application program and perform processing of various pieces of data and calculations. The processor 2310 may be implemented by, for example, a system on chip (SoC). According to an embodiment of the present disclosure, the processor 2310 may further include a graphic processing unit (GPU) and/or an image signal processor (ISP). The processor 2310 may include at least some (for example, a cellular module 2321) of the elements illustrated in FIG. 23. The processor 2310 may load, into a volatile memory, instructions or data received from at least one (for example, a non-volatile memory) of the other elements and may process the loaded instructions or data, and may store various data in a non-volatile memory.

The communication module 2320 may have a configuration equal or similar to that of the communication interface 170 of FIG. 1. The communication module 2320 may include, for example, the cellular module 2321, a Wi-Fi module 2323, a BT module 2325, a GNSS module 2327 (for example, a GPS module, a Glonass module, a Beidou module, or a Galileo module), an NFC module 2328, and a radio frequency (RF) module 2329.

The cellular module 2321 may provide a voice call, an image call, a text message service, or an Internet service through, for example, a communication network. According to an embodiment of the present disclosure, the cellular module 2321 may identify and authenticate the electronic device 2301 within a communication network using a SIM (for example, the SIM card 2324). According to an embodiment of the present disclosure, the cellular module 2321 may perform at least some of the functions that the processor 2310 may provide. According to an embodiment of the present disclosure, the cellular module 2321 may include a CP.

The Wi-Fi module 2323, the BT module 2325, the GNSS module 2327, or the NFC module 2328 may include, for example, a processor that processes data transmitted and received through the corresponding module. According to some embodiments of the present disclosure, at least some (for example, two or more) of the cellular module 2321, the Wi-Fi module 2323, the BT module 2325, the GNSS module 2327, and the NFC module 2328 may be included in one integrated chip (IC) or IC package.

The RF module 2329 may transmit/receive, for example, a communication signal (for example, an RF signal). The RF module 2329 may include, for example, a transceiver, a power amp module (PAM), a frequency filter, a low noise amplifier (LNA), or an antenna. According to another embodiment of the present disclosure, at least one of the cellular module 2321, the Wi-Fi module 2323, the BT module 2325, the GNSS module 2327, and the NFC module 2328 may transmit and receive RF signals through a separate RF module.

The SIM 2324 may include, for example, a card including a subscriber identity module and/or an embedded SIM, and may contain unique identification information (for example, an integrated circuit card identifier (ICCID)) or subscriber information (for example, an international mobile subscriber identity (IMSI)).

The memory 2330 (for example, the memory 130) may include, for example, an internal memory 2332 or an external memory 2334. The internal memory 2332 may include at least one of a volatile memory (for example, a dynamic RAM (DRAM), a static RAM (SRAM), a synchronous DRAM (SDRAM), and the like) and a non-volatile memory (for example, a one time programmable ROM (OTPROM), a PROM, an erasable and programmable ROM (EPROM), an electrically erasable and programmable ROM (EEPROM), a mask ROM, a flash ROM, a flash memory (for example, a NAND flash memory or a NOR flash memory), a hard disk drive, a solid state drive (SSD), and the like).

The external memory 2334 may further include a flash drive, for example, a compact flash (CF), a SD, a micro SD (Micro-SD), a mini SD (Mini-SD), an xD, a memory stick, or the like. The external memory 2334 may be functionally and/or physically connected to the electronic device 2301 through various interfaces.

The sensor module 2340 may measure a physical quantity or detect an operation state of the electronic device 2301, and may convert the measured or detected information into an electrical signal. The sensor module 2340 may include, for example, at least one of a gesture sensor 2340A, a gyro sensor 2340B, an atmospheric pressure sensor 2340C, a magnetic sensor 2340D, an acceleration sensor 2340E, a grip sensor 2340F, a proximity sensor 2340G, a color or RGB sensor 2340H (for example, a red, green, blue (RGB) sensor), a biometric sensor 2340I, a temperature/humidity sensor 2340J, a light sensor 2340K, and a ultraviolet (UV) sensor 2340M. Additionally or alternatively, the sensor module 2340 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 2340 may further include a control circuit for controlling one or more sensors included therein. In some embodiments of the present disclosure, the electronic device 2301 may further include a processor configured to control the sensor module 2340 as a part of or separately from the processor 2310, and may control the sensor module 2340 while the processor 2310 is in a sleep state.

The input device 2350 may include, for example, a touch panel 2352, a (digital) pen sensor 2354, a key 2356, and an ultrasonic input unit 2358. The touch panel 2352 may use at least one of, for example, a capacitive type, a resistive type, an infrared type, and an ultrasonic type. Also, the touch panel 2352 may further include a control circuit. The touch panel 2352 may further include a tactile layer and provide a tactile reaction to the user.

The (digital) pen sensor 2354 may include, for example, a recognition sheet which is a part of the touch panel or is separated from the touch panel. The key 2356 may include, for example, a physical button, an optical key or a keypad. The ultrasonic input device 2358 may detect ultrasonic waves generated by an input tool through a microphone (for example, a microphone 2388) and identify data corresponding to the detected ultrasonic waves.

The display 2360 (for example, the display 160) may include a panel 2362, a hologram device 2364 or a projector 2366. The panel 2362 may include a configuration identical or similar to that of the display 160 illustrated in FIG. 1. The panel 2362 may be implemented to be, for example, flexible, transparent, or wearable. The panel 2362 and the touch panel 2352 may be implemented as one module. The hologram 2364 may show a three dimensional image in the air by using an interference of light. The projector 2366 may display an image by projecting light onto a screen. The screen may be located, for example, inside or outside the electronic device 2301. According to an embodiment of the present disclosure, the display 2360 may further include a control circuit for controlling the panel 2362, the hologram device 2364, or the projector 2366.

The interface 2370 may include, for example, a HDMI 2372, a USB 2374, an optical interface 2376, or a D-subminiature (D-sub) 2378. The interface 2370 may be included in, for example, the communication interface 170 illustrated in FIG. 1. Additionally or alternatively, the interface 2370 may include, for example, a mobile high-definition link (MHL) interface, a SD card/multi-media card (MMC) interface, or an Infrared Data Association (IrDA) standard interface.

The audio module 2380 may bilaterally convert, for example, a sound and an electrical signal. At least some elements of the audio module 2380 may be included in, for example, the input/output interface 150 illustrated in FIG. 1. The audio module 2380 may process sound information which is input or output through, for example, a speaker 2382, a receiver 2384, earphones 2386, the microphone 2388 or the like.

The camera module 2391 is a device which may photograph a still image and a dynamic image. According to an embodiment of the present disclosure, the camera module 2391 may include one or more image sensors (for example, a front sensor or a back sensor), a lens, an ISP or a flash (for example, LED or xenon lamp).

The power management module 2395 may manage, for example, power of the electronic device 2301. According to an embodiment of the present disclosure, the power management module 2395 may include a power management integrated circuit (PMIC), a charger integrated circuit (IC), or a battery or fuel gauge. The PMIC may use a wired and/or wireless charging method. Examples of the wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery gauge may measure, for example, a residual quantity of the battery 2396, and a voltage, a current, or a temperature during the charging. The battery 2396 may include, for example, a rechargeable battery or a solar battery.

The indicator 2397 may display a particular state (for example, a booting state, a message state, a charging state, or the like) of the electronic device 2301 or a part (for example, the processor 2310) of the electronic device 2301. The motor 2398 may convert an electrical signal into mechanical vibration, and may generate vibration, a haptic effect, or the like. Although not illustrated, the electronic device 2301 may include a processing unit (for example, a GPU) for supporting a mobile TV. The processing unit for supporting mobile TV may, for example, process media data according to a certain standard such as digital multimedia broadcasting (DMB), digital video broadcasting (DVB), or mediaFlo™.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

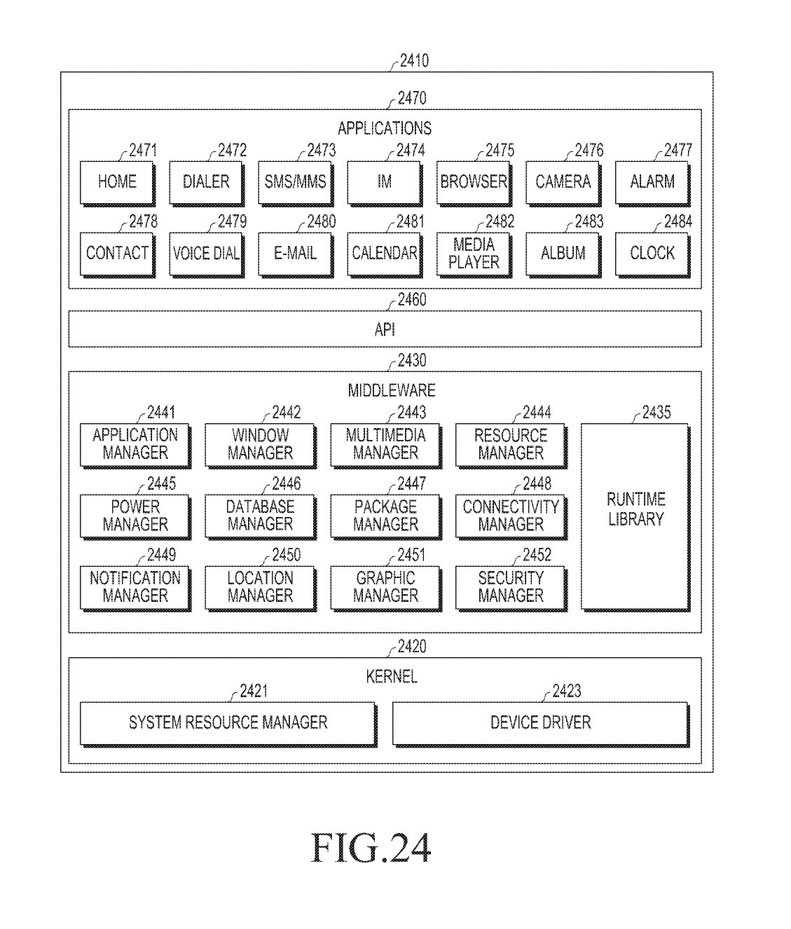

FIG. 24 is a block diagram of a program module according to various embodiments of the present disclosure. According to an embodiment of the present disclosure, the program module 2410 (for example, the program 140) may include an OS for controlling resources related to the electronic device (for example, the electronic device 101) and/or various applications (for example, the application programs 147) executed in the OS. The OS may be, for example, Android, iOS, Windows, Symbian, Tizen, Bada, or the like.

The program module 2410 may include a kernel 2420, middleware 2430, an API 2460, and/or applications 2470. At least some of the program module 2410 may be preloaded on the electronic device, or may be downloaded from an external electronic device (for example, the electronic device 102 or 104, or the server 106).

The kernel 2420 (for example, the kernel 141) may include, for example, a system resource manager 2421 and/or a device driver 2423. The system resource manager 2421 may perform the control, allocation, retrieval, or the like of system resources. According to an embodiment of the present disclosure, the system resource manager 2421 may include a process manager, a memory manager, a file system manager, or the like. The device driver 2423 may include, for example, a display driver, a camera driver, a BT driver, a shared memory driver, a USB driver, a keypad driver, a Wi-Fi driver, an audio driver, or an inter-process communication (IPC) driver.

The middleware 2430 may provide, for example, a function commonly required by the applications 2470, or may provide various functions to the applications 2470 through the API 2460 so that the applications 2470 can efficiently use limited system resources within the electronic device. According to an embodiment of the present disclosure, the middleware 2430 (for example, the middleware 143) may include, for example, at least one of a runtime library 2435, an application manager 2441, a window manager 2442, a multimedia manager 2443, a resource manager 2444, a power manager 2445, a database manager 2446, a package manager 2447, a connectivity manager 2448, a notification manager 2449, a location manager 2450, a graphic manager 2451, and a security manager 2452.

The runtime library 2435 may include a library module that a compiler uses in order to add a new function through a programming language while the applications 2470 are being executed. The runtime library 2435 may perform input/output management, memory management, the functionality for an arithmetic function, or the like.

The application manager 2441 may manage, for example, a life cycle of at least one of the applications 2470. The window manager 2442 may manage graphical user interface (GUI) resources used for the screen. The multimedia manager 2443 may determine a format required to reproduce various media files, and may encode or decode a media file by using a coder/decoder (codec) appropriate for the corresponding format. The resource manager 2444 may manage resources, such as a source code, a memory, a storage space, and the like of at least one of the applications 2470.

The power manager 2445 may operate together with a basic input/output system (BIOS) to manage a battery or power, and may provide power information required for the operation of the electronic device. The database manager 2446 may generate, search for, and/or change a database to be used by at least one of the applications 2470. The package manager 2447 may manage the installation or update of an application distributed in the form of a package file.

The connectivity manager 2448 may manage a wireless connection such as, for example, Wi-Fi or BT. The notification manager 2449 may display or notify of an event, such as an arrival message, an appointment, a proximity notification, and the like, in such a manner as not to disturb the user. The location manager 2450 may manage location information of the electronic device. The graphic manager 2451 may manage a graphic effect, which is to be provided to the user, or a user interface related to the graphic effect. The security manager 2452 may provide various security functions required for system security, user authentication, and the like. According to an embodiment of the present disclosure, when the electronic device (for example, the electronic device 101) has a telephone call function, the middleware 2430 may further include a telephony manager for managing a voice call function or a video call function of the electronic device.

The middleware 2430 may include a middleware module that forms a combination of various functions of the above-described elements. The middleware 2430 may provide a module specialized for each type of OS in order to provide a differentiated function. Also, the middleware 2430 may dynamically delete some of the existing elements, or may add new elements.

The API 2460 (for example, the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 2470 (for example, the application programs 147) may include, for example, one or more applications which can provide functions such as home 2471, dialer 2472, SMS/MMS 2473, instant message (IM) 2474, browser 2475, camera 2476, alarm 2477, contacts 2478, voice dial 2479, email 2480, calendar 2481, media player 2482, album 2483, clock 2484, health care (for example, measure exercise quantity or blood sugar), or environment information (for example, atmospheric pressure, humidity, or temperature information).

According to an embodiment of the present disclosure, the applications 2470 may include an application (hereinafter, referred to as an “information exchange application” for convenience of description) supporting information exchange between the electronic device (for example, the electronic device 101) and an external electronic device (for example, the electronic device 102 or 104). The application associated with the exchange of information may include, for example, a notification relay application for transferring specific information to an external electronic device or a device management application for managing an external electronic device.

For example, the notification relay application may include a function of transferring, to the external electronic device (for example, the electronic device 102 or 104), notification information generated from the other applications of the electronic device (for example, the SMS/MMS application, the e-mail application, the health management application, and the environmental information application). Further, the notification relay application may receive notification information from, for example, an external electronic device and provide the received notification information to a user.

The device management application may manage (for example, install, delete, or update), for example, a function for at least a part of the external electronic device (for example, the electronic device 102 or 104) communicating with the electronic device (for example, turning on/off the external electronic device itself (or some elements thereof) or adjusting brightness (or resolution) of a display), applications executed in the external electronic device, or services provided from the external electronic device (for example, a telephone call service or a message service).

According to an embodiment of the present disclosure, the applications 2470 may include applications (for example, a health care application of a mobile medical appliance or the like) designated according to attributes of the external electronic device 102 or 104. According to an embodiment of the present disclosure, the application 2470 may include an application received from the external electronic device (for example, the server 106, or the electronic device 102 or 104). According to an embodiment of the present disclosure, the application 2470 may include a preloaded application or a third party application which can be downloaded from the server. Names of the elements of the program module 2410, according to the above-described embodiments of the present disclosure, may change depending on the type of OS.

According to various embodiments of the present disclosure, at least some of the program module 2410 may be implemented in software, firmware, hardware, or a combination of two or more thereof. At least some of the program module 2410 may be implemented (e.g., executed) by, for example, the processor (e.g., the processor 210). At least some of the program module 2410 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate arrays (FPGA), and a programmable-logic device for performing operations which has been known or are to be developed hereinafter.

According to various embodiments of the present disclosure, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a compact disc ROM (CD-ROM) and a DVD), magneto-optical media (e.g., a floptical disk), a hardware device (e.g., a ROM, a RAM, a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

According to various embodiments of the present disclosure, a computer-readable recording medium, which is a storage medium storing commands configured to perform one or more operations by at least one processor when the commands are executed by the at least one processor, and has a program recorded therein to execute the one or more operations is provided. The one or more operations may includes displaying a message received from an external electronic device by an electronic device, the displaying of the message comprising presenting first background information in connection with the message, identifying context information related to the message; determining second background information based on the context information, and providing the second background information in connection with the displayed message.

According to various embodiments of the present disclosure, a computer-readable recording medium, which is a storage medium storing commands configured to perform one or more operations by at least one processor when the commands are executed by the at least one processor, and has a program recorded therein to execute the one or more operations is provided. The one or more operations may includes displaying at least one message on the display screen identifying context information related to the at least one message, and providing background information of a message display area of the display screen based on the identified context information.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method comprising:
displaying a message received from an external electronic device by an electronic device, the displaying of the message comprising:
presenting first background information in connection with the message;
identifying context information related to the message;
determining second background information based on the context information; and
providing the second background information in connection with the displayed message.

2. The method of claim 1, wherein the identifying of the context information comprises:
identifying, as the context information, at least one piece of information of a time, weather, date, temperature, location, and schedule when the message is received or transmitted;
identifying user's biometric information; and
identifying information contained in the message,
wherein the message includes at least one of atext, a voice, a sound, an email, a photo, and a video.

3. The method of claim 1, wherein the determining of the second background information comprises determining at least one of an image, a video, a sound, a smell, and a vibration as the second background information based on the context information.

4. The method of claim 1, wherein the providing of the second background information comprises, when the context information corresponds to an image, displaying the image to a user through a display functionally connected to the electronic device.

5. The method of claim 1, wherein the providing of the second background information comprises moving and displaying at least one of the message and the second background information based on a user input.

6. An electronic device comprising:
at least one processor; and
at least one memory storing a plurality of pieces of background information including first background information and second background information and computer program instructions configured, when executed by the at least one processor, to cause the electronic device at least to perform:
managing a message;
displaying the message received from an external electronic device, wherein the displaying of the message comprising providing first background information in connection with the message, to identify context information related to the message;
selecting second background information based on the context information; and
providing the second background information in connection with the displayed message.

7. The electronic device of claim 6, wherein the computer program instructions are further configured, when executed by the at least one processor, to cause the electronic device to perform:
identifying the context information, at least one piece of information related to a time, weather, date, temperature, location, and schedule when the message is received or transmitted, a user's biometric information, and information contained in the message,
wherein the message includes at least one of a text, a voice, a sound, an email, a photo, and a video.

8. The electronic device of claim 6, wherein the computer program instructions are further configured, when executed by the at least one processor, to cause the electronic device to perform:
determining at least one of an image, a video, a sound, a smell, and a vibration as the second background information based on the context information,
displaying the image to a user through a display functionally connected to the electronic device, and
moving and displaying at least one of the message and the second background information based on a user input.

9. An electronic device comprising:
a display for displaying at least one message on the display screen; and
a processor configured to:
identify context information related to the at least one message that is displayed on the display screen; and
provide background information of a message display area of the display screen based on the identified context information.

10. The electronic device of claim 9, wherein the processor is configred to:
collect contents corresponding to the identified context information,
generate the background information by using the collected contents, and
provide the generated background information as the background information of the message display area.

11. The electronic device of claim 9, wherein the processor is configred to:
move the at least one message displayed in the message display area in response to a user input, and
change the background information of the message display area in response to a movement of the at least one message,
wherein the background information of the message display area is chnaged to a background information stored in connection with a message moved to a preset location of the message display area, a background information generated based on context information that is identified using information related to the meved message, a background information generated based on a particular message skipped in response to a user input, or a background information generated based on at least one message from among a plurality of messages transmitted or received during a predetermined period.

12. The electronic device of claim 9, wherein the processor is configured to:
collect contents in accordance with the context information, and
generate at least one of an image, a video, a sound, a smell, and a vibration as the background information of the message display area by using the collected contents.

13. The electronic device of claim 9, wherein, when moving a plurality of messages arranged in the message display area in chronological order in response to a user input, the processor is configured to:
generate dynamic background information according to a time change based on a communication time of the plurality of messages; and
provide the generated dynamic background information as the background information of the message display area.

14. The electronic device of claim 9, wherein the processor is configured to:
display background information for another user in one area of on the display screen of the display to be separated from the message display area, and
change the background information of the message display area to background information for another user.

15. A method of processing information by an electronic device, the method comprising:
displaying at least one message on the display screen of a display;
identifying context information related to the at least one message; and
providing background information of a message display area of the display screen based on the identified context information.

16. The method of claim 15, wherein the providing of the background information of the message display area comprises:
collecting contents corresponding to the identified context information;
generating the background information by using the collected contents; and
providing the generated background information as the background information of the message display area.

17. The method of claim 15, wherein the providing of the background information of the message display area based on the identified context information comprises:
moving and displaying a plurality of messages arranged in the message display area in chronological order in response to a user input;
generating dynamic background information according to a time change based on a communication time of the plurality of messages; and
providing the generated dynamic background information as the background information of the message display area.

18. The method of claim 15, further comprising displaying background information for another user in one area of on the screen of the display to be separated from the message display area;
changing the background information of the message display area to background information for another user; and
providing the changed background information.

19. The method of claim 15, further comprising:
moving at least one of the message displayed in the message display area and the background information based on a user input; and
change the background information of the message display area in response to a movement of the at least one message,
wherein the background information of the message display area is chnaged to a background information stored in connection with a message moved to a preset location of the message display area, a background information generated based on context information that is identified using information related to the meved message, a background information generated based on a particular message skipped in response to a user input or a background information generated based on at least one message from among a plurality of messages transmitted or received during a predetermined period, and
wherein the background information of the message display area includes at least one of an image, a video, a sound, a smell, and a vibration, generated using collected contents in accordance with the context information.

20. A computer-readable recording medium, which is a storage medium storing commands configured to perform one or more operations by at least one processor when the commands are executed by the at least one processor, having a program recorded therein to execute the one or more operations, the one or more operations comprising:
displaying at least one message on the display screen of an electronic device;
identifying context information related to the at least one message; and
providing background information of a message display of the display screen area based on the identified context information.
